(19) United States
(12) Patent Application Publication
(10) Pub. No.: US 2023/0402654 A1
(43) Pub. Date: Dec. 14, 2023

(54) STABILIZED ELECTROLYTES FOR LOW-TEMPERATURE BATTERIES

(71) Applicant: THE REGENTS OF THE UNIVERSITY OF CALIFORNIA, Oakland, CA (US)

(72) Inventors: Zheng CHEN, San Diego, CA (US); Ping LIU, La Jolla, CA (US); John HOLOUBEK, La Jolla, CA (US)

(21) Appl. No.: 18/031,857

(22) PCT Filed: Oct. 18, 2021
(86) PCT No.: PCT/US2021/055478

§ 371 Date: Apr. 13, 2023

Related U.S. Application Data
(60) Provisional application No. 63/183,030, filed on May 2, 2021.
(60) Provisional application No. 63/093,043, filed on Oct. 16, 2020.

(51) Int. Cl. H01M 10/0569; H01M 10/0525; H01M 4/525; H01M 4/505; H01M 4/131

(52) U.S. Cl. CPC H01M 10/0569; H01M 10/0525; H01M 4/525; H01M 2300/0034; H01M 4/131; H01M 2300/0037; H01M 4/505

(57) ABSTRACT

Lithium batteries (LBs) are formed using an electrolyte including a lithium salt in an ester primary solvent with a low percentage of about 5% to about 30% of an ethylene carbonate (EC). The batteries exhibit high electrochemical stability and ionic conductivity at low temperatures.

### RELATED APPLICATIONS

This application claims the benefit of the priority of each of U.S. Provisional Application No. 63/093,043, filed Oct. 16, 2020, and U.S. Provisional Application No. 63/183,030, filed May 2, 2021, each of which is incorporated herein by reference in its entirety.

### GOVERNMENT RIGHTS

This invention was made with government support under Space Technology Research Grant No. 80NSSC18K1512 awarded by the National Aeronautics and Space Administration. The government has certain rights in the invention.

### FIELD OF THE INVENTION

The present invention relates to formulations, designs and devices that pertain to novel electrolytes with high electrochemical stability and ionic conductivity at low temperature and the low-temperature batteries that they enable. The invention optimizes energy and power delivery of the battery with desirable thermal properties in battery electrolytes.

### BACKGROUND

The advent of lithium-ion batteries (LIBs) has enabled the rapid development of portable electronics and electric vehicles due to their relatively high specific energy and long cycle life under mild operating conditions. Applications of LIBs have been expanding from the already-commercialized mobile phones and laptop computers to electric vehicles (EVs) and energy storage systems (ESSs). In accordance with the diverse applications of LIBs, the cells should be able to maintain their energy and power densities under a wide range of operating temperatures. However, typical LIBs encounter severe performance losses at sub-zero temperatures, primarily due to the carbonate-based liquid electrolytes, which hinders the deployment of high altitude drones and advanced electronics in space. In particular, power density suffers severely, where early studies observed that a commercial LIB retaining 5% of its energy density at −40° C. only retained 1.25% of its power density.

External battery warming systems are typically applied to circumvent this issue, where device charging in harsh environments can be aided by additional components that have recently been demonstrated with minimal impact to total cell mass. However, these heating systems are untenable for discharge as a standalone system due to their non-negligible startup times, requiring a source of high current for initial activation.

Furthermore, many devices requiring low temperature discharge do not require warming systems for charging due to the nature of their operation (e.g., high-altitude drones are charged at low altitudes). For these reasons, the field has traditionally focused on performance retention at low-temperature during discharge after charging under mild conditions.

Approaches to improve low-temperature discharge performance generally focus on the battery electrolyte, which facilitates the transport of ions between electrodes and governs a set of discrete cell impedance contributors. For a typical discharging LIB, these contributions are generally summarized as: 1) migration through the solid-electrolyte-interface (SEI), 2) bulk ionic transport, and 3) charge-transfer, which is dominated by Li⁺ de-solvation at the positive electrode interface. These resistances are all significantly exacerbated at temperatures <−20 ° C. and at high discharge rate, where Li⁺ de-solvation in particular has been observed to dominate the capacity fade. In general, these resistances have been minimized by employing low melting-point solvents, and novel salt additives. While progress has been made, it is important to note that these advancements have primarily been applied to conventional LIBs containing transition-metal oxide electrodes. These electrodes operate via the “rocking chair” mechanism, where Li⁺ diffuses from negative electrode to positive electrode during discharge, undergoing solvation at the negative electrode interface and de-solvation at the positive electrode interface. As a consequence of this mechanism, sluggish Li⁺ desolvation is unavoidable during both charge and discharge of LIBs. This is not the case for dual-ion batteries (DIBs)—DIBs store both cations and anions during charge, which migrate back into the electrolyte during discharge. This “salt-splitting” mechanism intrinsically decouples solvation and desolvation, where ions undergo desolvation on both electrodes during charge and solvation on both electrodes during discharge, theoretically circumventing the desolvation barrier. Furthermore, the weak solvation of anions suggests that the de-solvation barrier would have little effect on the positive electrode kinetics. These factors indicate that DIBs have the potential to kinetically outperform LIBs at extremely low temperature.

Anion-storing DIB positive electrodes typically fall into the following categories: anion doping in polymers, anion insertion in metal-organic frameworks (MOFs), halogen conversion in graphite, and anion intercalation in graphite. Polymers have recently shown promise for low temperature devices, however the poor volumetric energy density and low electronic conductivity of polymer electrodes hinders their widespread adoption. Furthermore, halogen conversion has yet to be realized in organic electrolytes, and the unclear solvation/desolvation mechanics at the electrode interface of polymers and MOFs overcomplicates a direct comparison between DIB and LIB mechanisms. The well-known intercalation-based graphite positive electrode would be an ideal candidate to make such a comparison, however until now, an electrolyte system with adequate oxidative stability and low temperature ionic conductivity has not been demonstrated.

### SUMMARY

Improving the low temperature operation of rechargeable batteries is vital to the operation of electronics in extreme environments, where systems capable of high-rate discharge are in short supply. In a first implementation, the inventive approach employs a holistic design of dual-graphite batteries to circumvent the sluggish ion desolvation process found in typical lithium-ion batteries during discharge. These batteries were enabled by the novel electrolyte, which simultaneously provides high electrochemical stability and ionic conductivity at low temperature. The dual-graphite cells, when compared to industry-type graphite∥LiCoO₂ full-cells demonstrated an eleven-fold increased capacity retention at −60° C. for a 10C discharge rate, indicative of the superior kinetics of the “dual-ion” storage mechanism. These trends are further supported by GITT and EIS measurements at reduced temperature. The inventive approach provides a new design strategy for extreme low-temperature batteries.

Many solvents with wide liquid-phase temperature ranges, such as methyl propionate (−88° C. to 80° C.) lack the electrochemical stability to be employed at high volume content in battery electrolytes. The inventive approach solves this issue for multiple low-temperature electrolyte solvents through the addition of a low percentage (˜5% to —30%) additive to the primary ester-based solvent. In the examples described herein, a low percentage, e.g., 10% fluoroethylene carbonate (FEC) allows for superior thermal and electrochemical properties to be maintained by the primary solvent, an ester such as methyl propionate (MP), methyl butyrate (MB), methyl acetate (MA), methyl formate (MF), ethyl propionate (EP), ethyl butyrate (EB), propyl butyrate (PB), etc., or combinations thereof, while benefitting from high electrochemical stability provided by FEC in small amounts. It is believed that, in the prior art, the highest content of similar low-temperature solvents (melting point less than −50° C.) is 80% by volume (reported by Smart, et al (DOI:10.1016/j.jpowsour.2006.10.038). U.S. Pat. No. 9,293,773 of Smart et al. (incorporated herein by reference) discloses ester-based electrolyte systems for use in electrochemical cells, however, the reported results only described contents of up to 70% of the ester. A prototype battery system using these electrolytes was assembled, providing a capacity retention of 50% at −60° C. with a 0.5C discharge rate. In contrast, an analogous battery system employing the inventive electrolyte provided 67.5% retention under the same conditions with significantly higher voltage retention. Furthermore, the inventive approach is not only applicable to ester solvents investigated by Smart, et al. where a similar effect has been observed in other wide temperature solvents such as 3-methoxypropionitrile, which is unstable in mixtures of 100% and stable in mixtures with 10% fluoroethylene carbonate.

A second implementation of the inventive low-temperature electrolyte solvent involves substituting the primary solvent MP with its fluorinated counterpart, methyl 3,3,3-trifluoropionate (MTFP), which has previously been applied to high voltage systems as a low-percentage additive.

In still another implementation of the inventive concept of a low-temperature electrolyte solvent blend, stable charge and discharge cycling of LiNi_{0.33}Co_{0.33}Mn_{0.33}O₂ (NMC111)∥graphite pouch-type full cells at temperature as low as −40° C. is achieved using an ester-based electrolyte consisting of MP: FEC (90:10 vol. %) with 1 M LiPF₆ (referred to herein as “M9F1”). Use of the novel electrolyte provided significantly enhanced electrochemical cycling performance at −20° C., far superior to the industry standard carbonate electrolytes. It also maintains 60% capacity retention at −40° C. compared with room temperature charge and discharge operation.

In one aspect of the invention, a method for enhancing electrochemical stability of a battery electrolyte in a lithium battery includes adding ethylene carbonate (EC) in an amount of about 5% to about 30% to a primary solvent. The primary solvent may be selected from the group consisting of methyl propionate (MP), methyl butyrate (MB), methyl acetate (MA), methyl formate (MF), ethyl propionate (EP), ethyl butyrate (EB), and propyl butyrate (PB). In some embodiments, the primary solvent is methyl propionate (MP) and a ratio of MP to EC is 90:10 vol. %. The ethylene carbonate may be fluoroethylene carbonate (FEC). The lithium battery may be selected from the group consisting of graphite∥graphite dual-ion batteries (DIB), Li-sulfurized polyacrylonitrile (Li∥SPAN) batteries, graphite∥LiMnₓNi_{y}Co_{z}O₂ (NMC) batteries, graphite∥LiCoO₂ batteries, graphite∥LiMn₂O₄ batteries, and graphite∥LiFePO₄ batteries. The lithium battery may be a lithium ion battery, where the lithium ion battery is graphite anode and a cathode selected from LiCO₂, NMC, LiMn₂O₄, LiFePO₄ or a combination thereof, or a lithium metal battery comprising a graphite anode and a cathode selected from LiCO₂, NMC, LiMn₂O₄, LiFePO₄, SPAN, other transition metal oxides, sulfides, fluorides or combinations thereof. The battery electrolyte may be 1M to 2 M LiPF₆ in a solvent comprising MP with 10% (v/v) FEC.

In another aspect of the invention, an electrolyte for a lithium battery includes a lithium salt in a solvent having an ester primary solvent and a low percentage of about 5% to about 30% of fluoroethylene carbonate (FEC). The ester primary solvent may be selected from the group consisting of methyl propionate (MP), methyl butyrate (MB), methyl acetate (MA), methyl formate (MF), ethyl propionate (EP), ethyl butyrate (EB), and propyl butyrate (PB). In some embodiments, the primary solvent is methyl propionate (MP) and a ratio of MP to FEC is 90:10 vol. %. The lithium battery may be selected from the group consisting of graphite∥graphite dual-ion batteries (DIB), Li-sulfurized polyacrylonitrile (Li∥SPAN) batteries, graphite∥LiMnₓNi_{y}Co_{z}O₂ (NMC) batteries, graphite∥LiCoO₂ batteries, graphite∥LiMn₂O₄ batteries, and graphite∥LiFePO₄ batteries. The lithium battery may be a lithium ion battery, where the lithium ion battery is graphite anode and a cathode selected from LiCO₂, NMC, LiMn₂O₄, LiFePO₄ or a combination thereof, or a lithium metal battery comprising a graphite anode and a cathode selected from LiCO₂, NMC, LiMn₂O₄, LiFePO₄, SPAN, other transition metal oxides, sulfides, fluorides or combinations thereof. The battery electrolyte may be 1M to 2 M LiPF₆ in a solvent comprising MP with 10% (v/v) FEC.

In still another aspect of the invention, a lithium battery having enhanced electrochemical stability includes an electrolyte having a mixture of a primary solvent and an amount of about 5% to about 30% ethylene carbonate. In some embodiments, the electrolyte further includes a lithium salt, which may be LiPF₆. The primary solvent may be selected from the group consisting of methyl propionate (MP), methyl butyrate (MB), methyl acetate (MA), methyl formate (MF), ethyl propionate (EP), ethyl butyrate (EB), and propyl butyrate (PB). In some embodiments, the primary solvent is methyl propionate (MP) and a ratio of MP to FEC is 90:10 vol. %. The lithium battery may be a lithium-ion battery or a lithium metal battery. Lithium ion batteries may be selected from the group consisting of graphite∥graphite dual-ion batteries (DIB), Li-sulfurized polyacrylonitrile (Li∥SPAN) batteries, graphite∥LiMnₓNi_{y}Co_{z}O₂ batteries, graphite∥LiCoO₂ batteries, graphite∥LiMn₂O₄ batteries, and graphite∥LiFePO₄ batteries. In some embodiments, the lithium battery is a lithium metal battery comprising a graphite anode and a cathode selected from LiCO₂, NMC, LiMn₂O₄, LiFePO₄, SPAN, other transition metal oxides, sulfides, fluorides or combinations thereof. The battery electrolyte may be 1M to 2 M LiPF₆ in a solvent comprising MP with 10% (v/v) FEC.

The electrochemical stability provided by fluoroethylene carbonate to electrolytes based on previously unstable solvents likely operates via the formation of stable fluorine-rich interfaces where fluoroethylene carbonate decomposes to form organic fluorides and metallic fluorides, such as Li-F on the surface of the battery electrodes. This mechanism has been outlined in multiple battery publications, however, it is believed that this is the first time it has been applied as a stabilizing agent for low-temperature batteries in order to maximize the content of other previously unstable solvents.

Potential commercial applications of the inventive approach include batteries and super capacitors operating in low-temperature environments. The approaches described herein offer a new avenue for high-performance LIBs capable of ultra-low-temperature charging/discharging operation.

### BRIEF DESCRIPTION OF THE DRAWINGS

FIGS. 1A-1E illustrate characteristics of selected electrolytes, where FIG. 1A is a photograph of the electrolytes at −60° C.; FIG. 1B shows profiles of stainless-steel electrodes in electrolytes at 1 mV s⁻¹; FIG. 1C shows half-cell charge/discharge profiles of graphite negative electrodes in the electrolytes at 0.1 C; FIG. 1D plots the charge/discharge profiles at 0.1C in MP-based electrolytes with increasing FEC content; and FIG. 1E plots ionic conductivity of the electrolytes measured at different temperatures.

FIGS. 2A-2B illustrate operational schematics of Graphite∥LCO, and Graphite∥graphite full-cells, respectively; FIG. 2C provides CV profiles of the selected electrode half-cells in 2 M LiPF₆ in MP 10% FEC at 1 mV s⁻¹; Room temperature charge/discharge profiles of FIG. 2D) Graphite∥LCO and FIG. 2E) Graphite∥graphite full-cells at 1C (based on 140 mAh g⁻¹ and 80 mAh g⁻¹, respectively). FIG. 2F) Room temperature full-cell cycling performance at 1C. Dashed lines represent error bars.

FIGS. 3A-3B are discharge profiles of Graphite∥LCO, and Graphite∥Graphite full-cells at different temperatures and 1C rate; FIG. 3C plots discharge profiles of Graphite∥LCO full-cells in various electrolytes at −60° C. and 1 C rate; FIGS. 3D and 3E, respectively, plot Graphite∥LCO Graphite∥graphite full-cells in 2 M LiPF₆ in MP 10% FEC at different rates compared to room temperature (23° C.).

FIGS. 4A-4B are GITT discharge curves of LCO and Graphite half-cells, respectively, in 2 M LiPF₆ in MP 10% FEC at 1 C for room temperature and −60 ° C.; FIG. 4C plots measured ion diffusion coefficient during discharge in the selected positive electrodes at room temperature and −60 ° C.; FIGS. 4D and 4E show Nyquist impedance and equivalent circuit fitting of, respectively, LCO∥LCO and Graphite positive electrode∥graphite positive electrode coin cells at various temperatures in a 50% SOC condition; FIG. 4F shows summarized charge transfer resistance vs. temperature.

FIGS. 5A and 5B are diagrams of equivalent circuits employed in electrochemical impedance spectroscopy (EIS) evaluation of 50% SOC LCO∥LCO and 50% SOC graphite positive electrode∥graphite positive electrode symmetric cells.

FIG. 6A shows linear scan voltammetry (LSV) profiles of conductive carbon electrodes in selected electrolytes; FIGS. 6B and 6C provide comparisons of performance of ester electrolytes with and without FEC at 1 mVs⁻¹ for MP and MTFP, respectively; and FIG. 6D plots ionic conductivity of selected electrolytes measured at different temperatures.

FIG. 7A shows the cycling performance on NMC 811∥Li half-cells at 0.5 C for selected electrolytes; FIG. 7B shows voltage profiles at the 250^{th} cycle for different electrolytes.

FIGS. 8A-8C provide voltage profiles of NMC 811∥Li half-cells at different temperatures for electrolytes 1 M LiPF₆ EC/DEC, 1 M LiPF₆ MP/FEC, and 1 M LiPF₆ MTFP/FEC, respectively; and FIG. 8D compares room-temperature capacity retention for the different electrolytes in NMC 811∥Li half-cells.

FIG. 9A plots ionic conductivities (a) of different electrolytes measured at various temperatures from −60° C. to 30° C.; FIG. 9B shows differential scanning calorimetry (DSC) heating curves of different electrolytes with 1 M LiPF₆; FIGS. 9C and 9D are optical images of different electrolytes after storage for 12 hours at −20° C., and −80° C., respectively.

FIG. 10A provide the rate performance results of the NMC111∥graphite pouch cells and EIS analysis data of the cell at 0% SOC after cycling where FIG. 10A shows rate capabilities of full cells evaluated between 2.7 and 4.3 V voltage window using different electrolytes; FIG. 10B plots the normalized capacity retention from FIG. 10A; FIGS. 10C and 10D are Nyquist plots of the cells after rate capabilities at room temperature (RT) and −20° C., respectively.

FIG. 11A illustrates an equivalent circuit used for interpreting EIS spectra; FIGS. 11B and 11C plot the component values obtained by fitting the spectra in FIGS. 10C and 10D.

FIGS. 12A and 12B show results of room temperature cycling of NMC 111∥Graphite pouch cells at a 1 C rate, wherein FIG. 12A plots capacity vs. cycle and FIG. 12B shows relative energy retention.

FIGS. 13A-13E provide low-temperature electrochemical performance results for NMC111∥graphite type pouch cells using different electrolytes, where FIGS. 13A-13C are voltage profiles during discharge at 0.1C, 0.2C, and 0.5C, respectively under -20° C. after room-temperature charge at 0.1C; FIG. 13D provides charge and discharge cycling performance of cells at different C-rates (0.1C, 0.2C, and 0.5C) using different electrolytes; and FIG. 13E plots the normalized capacity retention at 1^{st} charge from FIG. 13D.

FIG. 14A shows the cathode and anode impedance contributions from the three-electrode pouch cell system comparing charge transfer resistance (R_{ct}) of the cells using different electrolytes at the temperatures between room temperature and −20° C.; FIGS. 14B-14D are Nyquist impedance plots of the cells using M9F1, LP40, and LP30, respectively.

FIGS. 15A-15C illustrate equivalent circuits and the corresponding fitting values for the impedance spectra for 3-electrode pouch cells for a full-cell, cathode, and anode, respectively.

FIGS. 16A and 16B show results of XPS characterization of electrode surfaces for O 1s (left panel) and F 1s (right panel) regions for graphite anodes, and NMC111 cathodes, respectively.

FIGS. 17A-17D are SEM images of the pristine (FIG. 17A) and cycled graphite electrodes at −20° C. in LP40 (FIG. 17B), LP30 (FIG. 17C), and M9F1(FIG. 17D); FIGS. 17E-17G are potential profiles at the first charge and discharge cycle of cells with LP40, LP30 and M9F1 electrolyte, respectively, at −20° C.

FIG. 18 plots the cycling stability of 3-layer pouch cells using M9F1 and M95F5 electrolyte at 0.1C rate.

FIG. 19A shows discharge voltage profiles of a pouch cell containing M9F1 at different temperatures; FIG. 19B plots low-temperature cycling of the cell containing M9F1 at 0.05C/0.05C for 15 cycles and then 0.05C/0.1C for charge and discharge, respectively.

FIG. 20 plots the cycling performance of cells at elevated temperature with different electrolytes.

### DETAILED DESCRIPTION OF EMBODIMENTS OF THE INVENTION

Carboxylate esters have been previously considered a promising additive solvent candidates for low-temperature LIB electrolytes due to their beneficial physiochemical properties. For example, ethyl acetate (EA) was previously chosen for its low freezing point (T_{f}) and suitable dielectric constant, which produces high ionic conductivity at ultralow temperature (−70° C). when paired with 1M LiTFSI. However, the cathodic stability was constrained to 1.5V vs. Li/Li⁺, suggesting that this electrolyte may not be capable of utilizing graphite as an anode. While higher-concentration carboxylate ester-based electrolytes were able to expand the reduction stability to ˜0 V (Li/Li⁺), the compatibility of such systems with full cell LIBs over long term cycles at low temperatures has rarely been reported.

To evaluate the inventive approach of employing an additive to improve the electrolyte's electrochemical stability, methyl propionate (MP), a common carboxylate ester, was chosen as the primary solvent based on its sufficient dielectric constant and low melting point. Table 1 below lists the properties of a number of potential solvents for use in lithium batteries, including, but not limited to, graphite∥graphite dual-ion batteries (DIB s), Li-sulfurized polyacrylonitrile (Li∥SPAN) batteries, graphite∥LiMnₓNi_{y}Co_{z}O₂ batteries, graphite∥LiCoO₂ batteries, graphite∥LiMn₂O₄ batteries, and graphite∥LiFePO₄ batteries. While previous ester systems have been demonstrated, the acetate family has generally been associated with poor reductive stability in addition to problematic high-temperature characteristics. MP is particularly attractive for low temperature electrolytes because of its low freezing temperature (−87.5° C.); relatively high boiling point of 79.8° C., and low viscosity (0.43 cP)

TABLE 1

| | | | Room Temp | Dielectric |
|---|---|---|---|---|
| | Melting T_{f} | Boiling | Viscosity | Constant |
| Solvent | (° C.) | T_{b} (° C.) | η_{RT} (cP) | ε_{RT} |
| Ethylene Carbonate (EC) | 36.4 | 248 | 1.95 (@ 40° C.) | 89.8 |
| Fluoroethylene Carbonate | 20 | 212 | 3.98 | 109.4 |
| (FEC) | | | | |
| Propylene Carbonate (PC) | −48.8 | 242 | 2.20 | 66.2 |
| Diethyl Carbonate (DEC) | −43.0 | 126 | 0.77 | 2.82 |
| Diethyl Carbonate (DMC) | 4.6 | 91 | 0.57 | 3.09 |
| Ethyl Acetate (EA) | −83.8 | 77 | 0.42 | 6.08 |
| Methyl Propionate (MP) | −87.5 | 79.8 | 0.43 | 6.20 |

Other candidates for uses as a primary solvent include methyl butyrate (MB: T_{f}=−95° C.; T_{b}=102° C.), methyl acetate (MA: T_{f}=−98° C.; T_{b}=134.8° C.), methyl formate (MF: T_{f}=−99° C.; T_{b}=31.8° C.), ethyl propionate (EP: T_{f}=−73.6° C.; T_{b}=98.9° C.), ethyl butyrate (EB T_{f}=−93° C.; T_{b}=120° C.), and propyl butyrate (PB: T_{f}=−95.2° C.; T_{b}=142° C.).

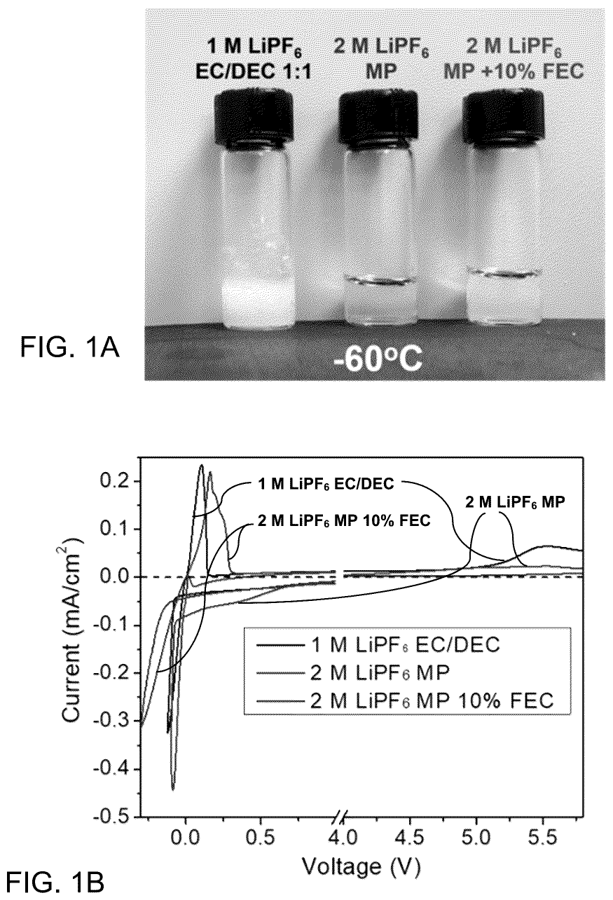

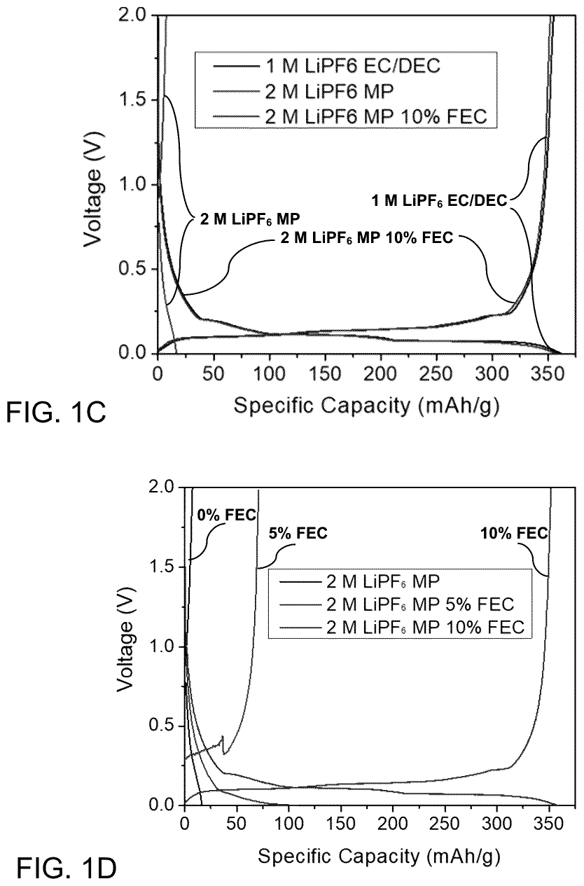

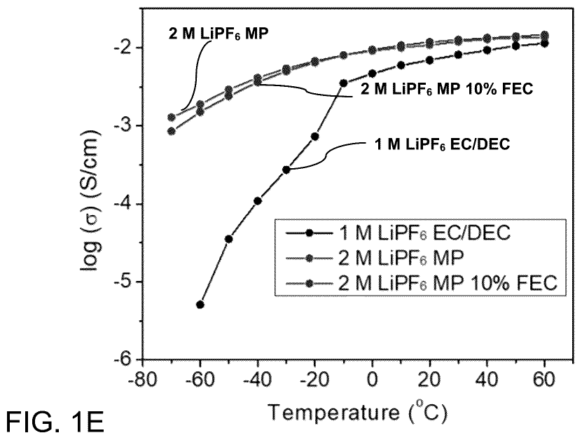

A number of lithium salts are known for use in lithium batteries including LiPF₆, LiTSFI, LiFSI, or combinations thereof. LiPF₆ was selected as the salt for the present testing of the novel solvent combination due to the established viability of PF₆⁻ intercalation in graphite, and 2 M concentration was selected to satisfy the concentration requirements of DIBs without producing a high viscosity. As shown in FIG. 1A, the MP-based electrolytes shown in the center and right containers in the image remain in liquid phase at −60° C., well past the freezing point of a typical electrolyte used in commercial batteries. The container on the left side of the image contains such an electrolyte: 1 M LiPF₆ in ethylene carbonate/diethyl carbonate or EC/DEC, 1:1 volume. While carboxylate esters have previously been applied in low-temperature batteries, their role has been limited to an additive to typical EC and ethyl methyl carbonate (EMC) based systems. Their limitation in this regard likely stems from poor reductive stability, where cyclic voltammetry (CV) of 2 M LiPF₆ in MP significant cathodic current beginning at 0.5 V vs. Li/Li⁺, and irreversible Li plating (FIG. 1B). To solve this issue, fluoroethylene carbonate (FEC), which is known to stabilize negative electrode and positive electrode interfaces was applied to the MP system, where 2 M LiPF₆ in MP with 10% (v/v) FEC (MP 10% FEC) additive shows the lowest anodic current at high voltage while enabling reversible Li plating at low voltage (FIG. 1B). The FEC additive also serves to build a solid-electrolyte interface (SEI) capable of enabling graphite negative electrodes, which is vital to the practicality of low temperature batteries until Li metal negative electrodes can be successfully enabled at high coulombic efficiency. However, as shown in FIG. 1C, the pure MP electrolyte without FEC fails to support charge/discharge of graphite negative electrodes. While higher FEC concentrations can likely achieve this, based on tests comparing FEC content at 0.1C in MP-based electrolytes (see FIG. 1D), we determined that 10% (v/v) FEC was most preferred to maximize the MP composition for a low overall melting point and viscosity.

The aforementioned electrolyte design principles are perhaps best exemplified in the measured ionic conductivity with decreasing temperature, plotted in FIG. 1E. Using an incremental impedance measurement technique, it was found that 2M LiPF₆ in MP retained a remarkable ionic conductivity of 1.89 mS cm⁻¹ at −60 ° C., which was slightly reduced to 1.50 mS cm⁻¹ with the addition of 10% FEC. This is in stark contrast to the commercial carbonate electrolyte, which falls to 0.0051 mS cm⁻¹ at −60° C.

For battery electrode preparation, synthetic graphite (average diameter: 21 μm; surface area: 4.2 m² g⁻; >99.5% purity) and LiCoO₂ (LCO, average diameter: 9 μm; surface area: 0.2-0.4 m² g⁻¹; >99% purity) powders were purchased from MTI Corporation. The homogenous positive electrode slurries were prepared by mixing graphite, super-P (TIMCAL, >99%), and sodium carboxymethyl cellulose (CMC, Mw ˜90,999 Sigma Aldrich) (8:1:1 in mass ratio) in deionized water, or LCO, super-P, and polyvinylidene fluoride (PVDF, KYNAR 2800) (8:1:1 in mass ratio) in N-methyl pyrrolidone (NMP, Sigma Aldrich >99.5%) for use in dual-ion and lithium-ion batteries, respectively. Similarly, graphite negative electrode slurries were prepared by mixing the same MTI graphite, carbon black (Alfa Aesar, >99.9%), and PVDF (8:1:1 in mass ratio) in NMP. Positive electrode and negative electrode slurries were spread on Al and Cu foil, respectively and dried overnight under vacuum at 80° C. The same graphite powder was applied in positive and negative electrodes to minimize the effects of particle morphology in an attempt to isolate the effect of the storage mechanisms. For electrolyte preparation, fluoroethylene carbonate (FEC, battery grade) and ethyl methyl carbonate (EMC, battery grade) was provided by CapChem, LiPF₆ (99.99%) and ethylene carbonate (EC, >99.9%) was purchased from BASF, and methyl propionate (MP, 99%) and 1 M LiPF₆ in ethylene carbonate/diethyl carbonate (EC/DEC 1:1, battery grade) were purchased from Sigma Aldrich. Low-temperature electrolytes were made by dissolving stoichiometric amounts of LiPF₆ in the selected solvents under stirring.

To evaluate the electrochemical performance, the prepared electrodes were fabricated into two-electrode CR-2032 type coin cells. Half-cells were evaluated with the electrolyte of interest using a Celgard 2400 poly-propylene membrane as the separator and Li metal (China Energy Lithium Co., 99.9%) as the counter electrode, where the working electrode had a typical mass loading of 3 mg cm⁻². For full-cells, the negative: positive electrode active mass ratios of 1:1.75 (N/P=1.5) and 1:2.3 (N/P=2.0) were employed for graphite∥LCO and graphite∥graphite cells, respectively with a typical negative electrode active mass of ·1.6-1.8 mg cm⁻². Graphite∥LCO full cells used Celgard 2400 separators (flooded, 75 μL) while graphite∥graphite cells used glass fiber separators flooded with 150 μL of electrolyte. Theoretical capacities of LCO and graphite positive electrodes were taken to be 140 mAh g⁻¹ and 80 mAh g⁻¹, respectively for C-rate determination. In the case of dual-graphite full cells, a pre-lithiation process was applied to the graphite negative electrode, similar to methods found in literature. The negative electrode was first assembled in a half-cell, cycled once at 0.1 C and then discharged to 0.3 V vs. Li/Li⁺ and held at the potential for 1 hour to stabilize the SEI before disassembly and subsequent reassembly in the full-cell. This method was also applied to graphite∥LCO cells to avoid any difference in SEI formation mechanics for low-temperature tests. All charge/discharge testing was performed on Neware BTS 4000 and Arbin LBT-10V5A systems. Error bars centered on average values for room temperature and low temperature data was based the standard deviation of 3 and 2 cells, respectively.

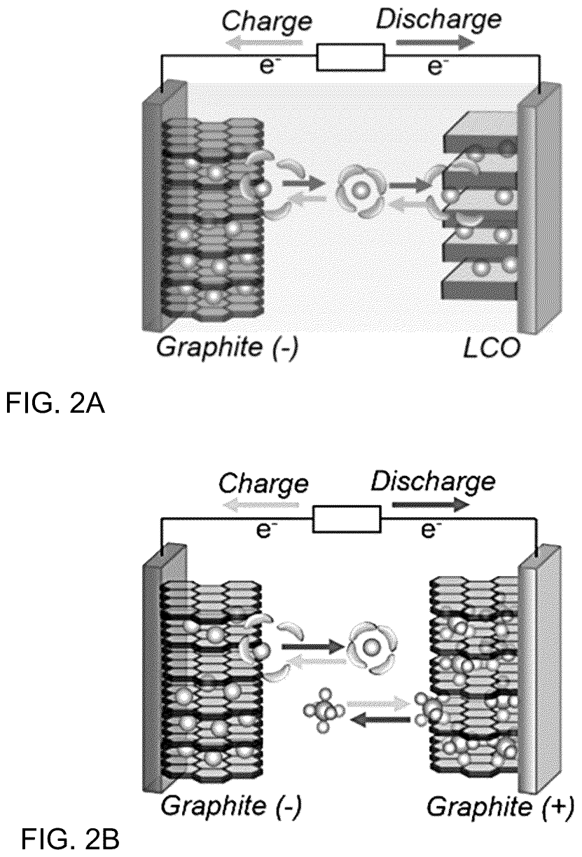

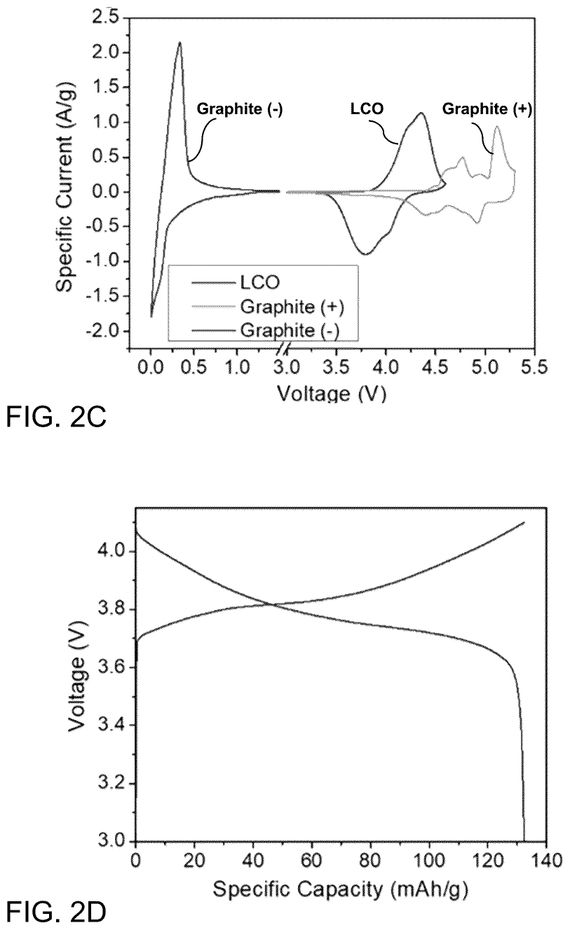

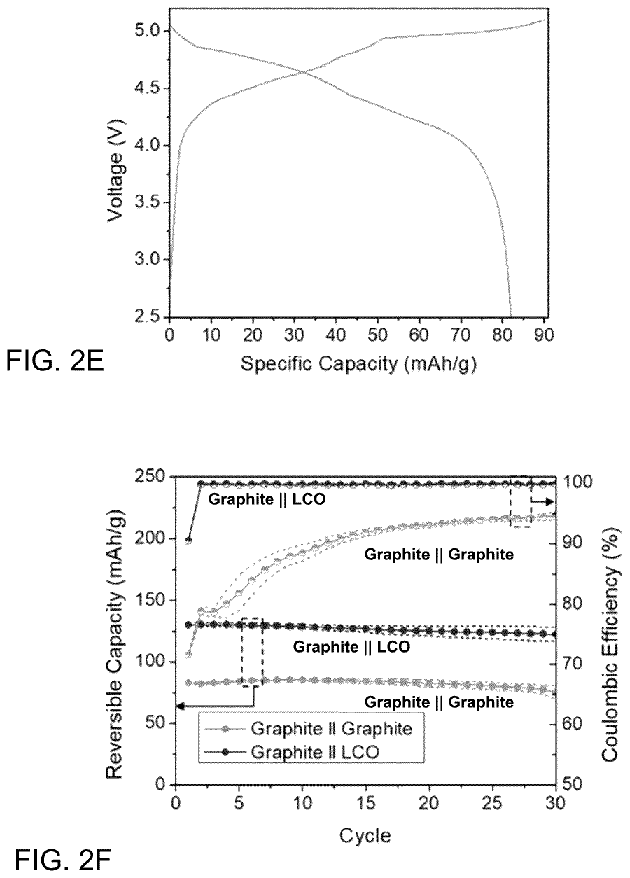

To evaluate DIBs and LIBs at low temperature we applied the 2 M LiPF₆ MP 10% of FEC electrolyte in graphite∥graphite and graphite∥LiCoO₂ (LCO) full-cells. Their charge storage mechanisms are shown in FIGS. 2A-2B, respectively, to illustrate the distinct solvation/desolvation behavior. The graphite positive electrode was found to exhibit lower specific capacity of 80 mAh g⁻¹ compared to the 138 mAh g⁻¹ of LCO due to the larger size of PF₆⁻ relative to Lit However, as shown in FIG. 2C, the storage of PF₆⁻ (˜4.6-5.2 V vs. Li/Li⁺) in graphite occurs at a much higher potential than Li⁺ in LCO (˜3.9-4.2 V vs. Li/Li⁺), indicating its viability in terms of energy output. These positive electrode chemistries were then applied in full cells with graphite negative electrodes with voltage profiles shown in FIGS. 2D-2E.

The cycling performance of these cells are shown in FIG. 2F, where stable performance was exhibited for both cells after a commonly applied initial pre-lithiation process for the DIB. The capacity fading of such cycling has been recently studied by Heidrich et al. (Energy Storage Mater. 2019, 21, 414-426), indicating that the irreversibility of the graphite positive electrode can potentially result in Li metal plating on the negative electrode.

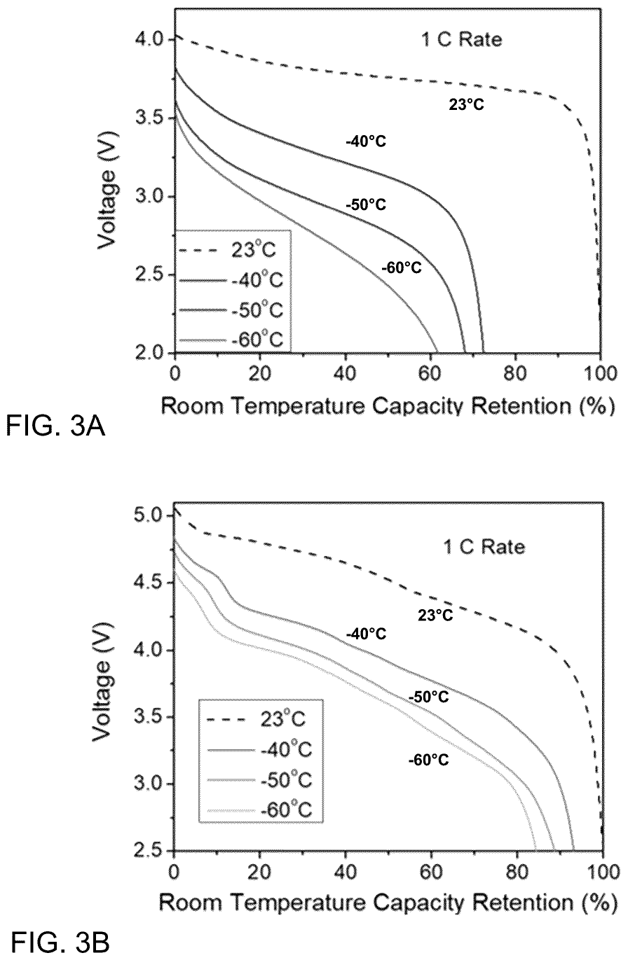

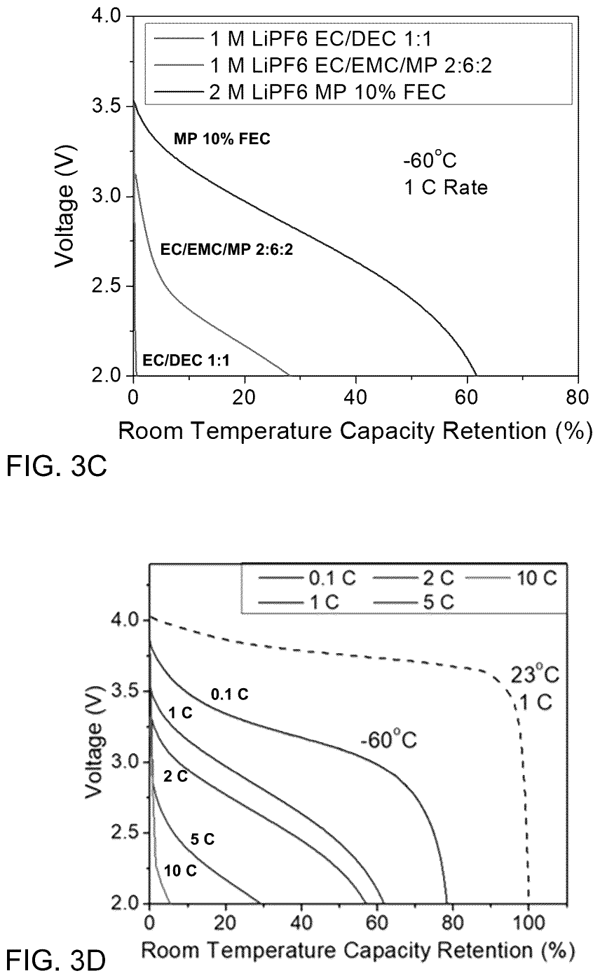

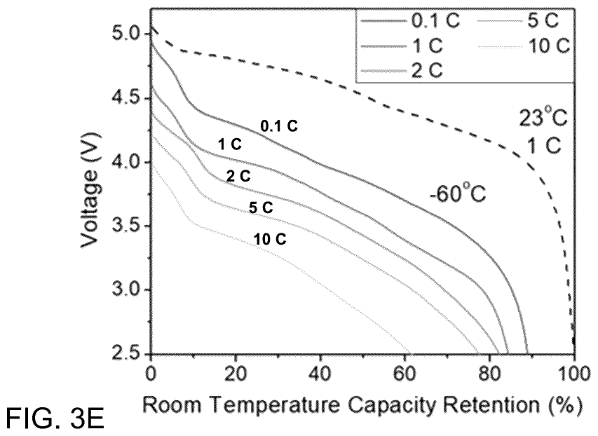

To simulate low temperature device operation, the assembled full-cells were then subjected to testing using a method similar to previous studies. At −40 ° C. with a 1 C discharge rate the graphite∥LCO LIB was found to retain 72.4% of its room temperature capacity, which decreased to 63.2% at −60° C. (FIG. 3A). It is worth noting that due to the adoption of the new electrolyte the graphite∥LCO control cell ranks among the best capacity retention for this temperature, as shown in the comparison of FIG. 3B. Despite the high-performing control, the graphite∥graphite DIB was found to far exceed the LIB capacity retention, retaining 93.1% and 84.4% of its room temperature capacity at −40 ° C. and −60 ° C., respectively (FIG. 3C). The low temperature improvement of the DIB mechanism was further investigated at −60° C. under different discharge rates, which provided perhaps the most salient deviation of performance metrics (FIGS. 3D-3E). At −60° C. and a 0.1 C discharge rate, the graphite∥LCO LIB and the graphite∥graphite DIB displayed 78.1% and 87.3% capacity retentions, respectively. However, when the rate was increased to 10 C, the DIB still exhibited 61.7%, whereas the LIB was unable to provide any significant capacity (5.5%) under the same conditions.

These trends notwithstanding, DIBs typically struggle to match LIBs in specific energy at a cell level due to the higher electrolyte volume demanded. Table 2 provides a summary of calculated average specific energies and standard deviations of the graphite∥LCO full-cells based on methods from Betz, et al. Table 3 summarizes calculated average specific energies and standard deviations of the graphite∥graphite full-cells. Nonetheless, DIBs could be ideal for applications requiring high power output at extremely low temperature due to the sluggish kinetics of LIBs.

TABLE 2

| | | | | Theoretical Specific |
|---|---|---|---|---|
| | | | Specific | Energy |
| Cell | | Discharge | Energy | (Wh/kg_{Pos. Electrodes} + |
| Configuration | Temp. | Rate (C) | (Wh/kg_{Electrodes}) | kg_{electrolyte}) |
| Graphite II | 23° C. | 0.1 | 326 ± 7 | 236 ± 5 |
| LCO | | | | |
| | | 1 | 318 ± 7 | 230 ± 5 |
| | | 2 | 310 ± 7 | 224 ± 5 |
| | | 5 | 293 ± 7 | 212 ± 5 |
| | | 10 | 272 ± 6 | 197 ± 4 |
| Graphite II | −60° C. | 0.1 | 202 ± 5 | 146 ± 3 |
| LCO | | | | |
| | | 1 | 140 ± 5 | 102 ± 2 |
| | | 2 | 123 ± 11 | 89 ± 1.9 |
| | | 5 | 56 ± 2.4 | 40 ± 0.9 |
| | | 10 | 9.8 ± 0.2 | 7.1 ± 0.2 |

TABLE 3

| | | | | Theoretical |
|---|---|---|---|---|
| | | | Specific | Specific Energy |
| Cell | | Discharge | Energy | (Wh/kg_{Pos. Electrodes} + |
| Configuration | Temp. | Rate (C) | (Wh/kg_{Electrodes}) | kg_{electrolyte}) |
| Graphite II | 23° C. | 0.1 | 326 ± 7 | 236 ± 5 |
| LCO | | | | |
| | | 1 | 318 ± 7 | 230 ± 5 |
| | | 2 | 310 ± 7 | 224 ± 5 |
| | | 5 | 293 ± 7 | 212 ± 5 |
| | | 10 | 272 ± 6 | 197 ± 4 |
| Graphite II | −60° C. | 0.1 | 202 ± 5 | 146 ± 3 |
| LCO | | | | |
| | | 1 | 140 ± 5 | 102 ± 2 |
| | | 2 | 123 ± 11 | 89 ± 1.9 |
| | | 5 | 56 ± 2.4 | 40 ± 0.9 |
| | | 10 | 9.8 ± 0.2 | 7.1 ± 0.2 |

To better understand the remarkable kinetic performance of the DIB at extremely low temperature, further electrochemical characterization was performed on the graphite and LCO positive electrodes to isolate the source of the two storage mechanisms.

The electrochemical stability of the electrolytes was investigated in coin cells using Cyclic Voltammetry (CV) of a stainless-steel working electrode vs. a Li metal counter on a Biologic VSP-300 potentiostat, which was also used to perform CV of the half-cells. For low temperature electrochemical tests, the full-cells were first cycled 5 times at room temperature with a rate of 1C. The cells were then charged at 1 C and held at their upper voltage cutoff for 30 minutes. The cells were then placed in the temperature chamber and allowed to rest for 1 hour to reach the set temperature, followed by discharging at various rates. The lower cutoff voltage was set at 1.5 V less than the end of full-cell's room temperature voltage plateaus. The SolidCold C4-76A ultra-low chest freezer with a secondary insulation chamber was used to maintain the cells at a specified temperature.

The galvanostatic intermittent titration technique (GITT) was applied to the positive electrode half-cells at a 1 C rate for current pulses of 60 seconds followed by resting periods of 30 minutes. For spherical particles and a short pulse time (r), the ion diffusion coefficient (D) was calculated based on:

$$D = \frac{4 {r}^{2}}{π τ} {( \frac{Δ {E}_{s}}{Δ {E}_{t}} )}^{2} \qquad ( 1 )$$

where r is the particle radius of the positive electrode material, ΔEₛ is the change in steady-state voltage, and ΔEₜ is the change in transient voltage. The half-cells were cycled 5 times at room-temperature before GITT tests. For EIS testing the electrodes of interest were first cycled in Li half-cells 5 times and then brought to 50% state of charge

(SOC) before disassembly and subsequent reassembly into the symmetric arrangement. EIS was performed on half-cells using a Biologic VSP-300 potentiostat from 1 MHz to 100 mHz with an AC amplitude of 5 mV. The R_{CT} values were obtained with the Z-Fit module in EC-Lab.

The theoretical specific energies of the full-cells were calculated in a method similar to the route suggested by Betz et al. (Adv. Energy Mater. 2019, 9, 1803170) excluding inactive materials found at the cell or stack levels. For the graphite∥LCO LIB system, the minimum electrolyte mass required to fill the positive and negative electrode and pores with an assumed porosity of 30% and 10 μm thickness. Because of the nature of the graphite∥graphite DIB mechanism, the electrolyte mass was determined based on the minimum electrolyte concentration required to satisfy the positive electrode capacity (80 mAh g⁻¹ for a 2 M electrolyte at 1.2 g/mL), with a 15% excess in order to maintain viable ionic conductivity. These theoretical electrolyte mass requirements were found to be

$$1.22 \frac{L}{{kg}_{c a t hode} + {kg}_{a n o d e}} and 0.381 \frac{L}{{kg}_{c a t hode} + {kg}_{a n o d e}}$$

for the DIB and LIB systems, respectively.

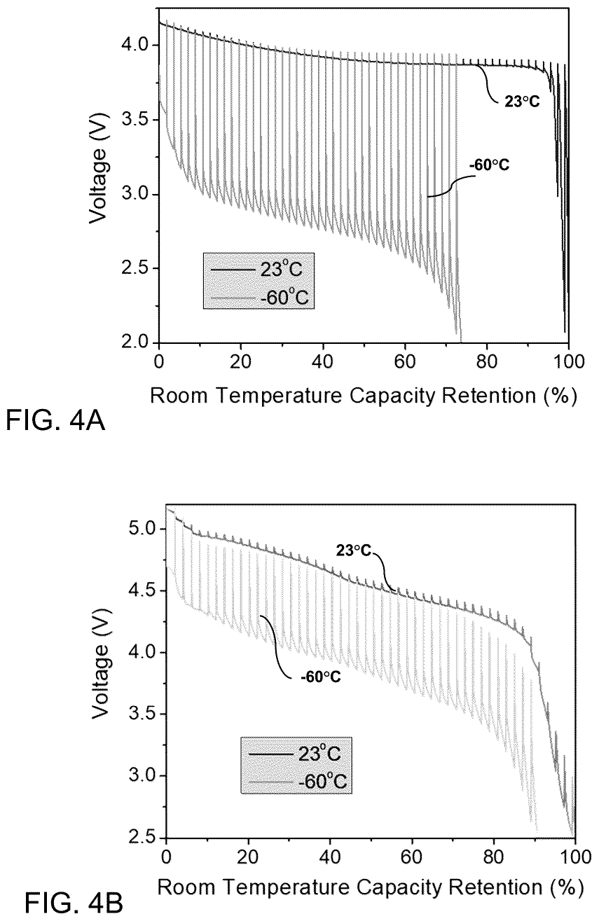

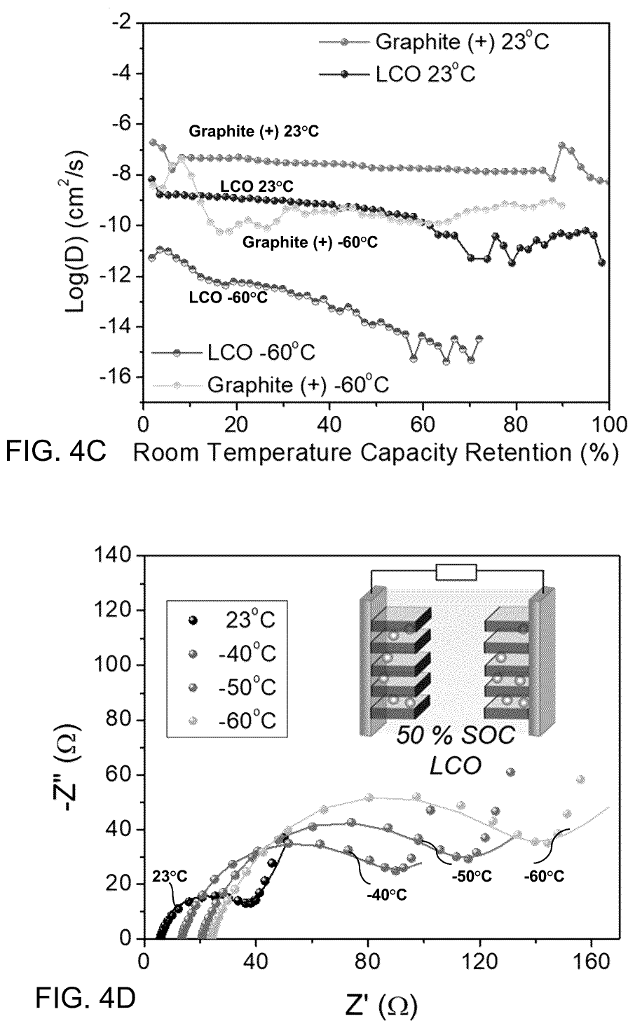

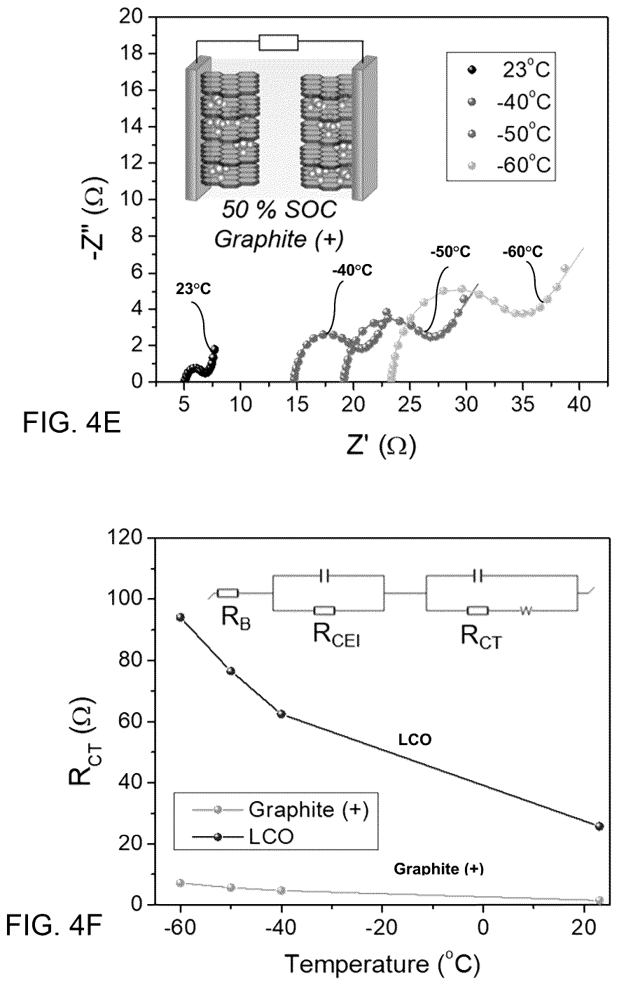

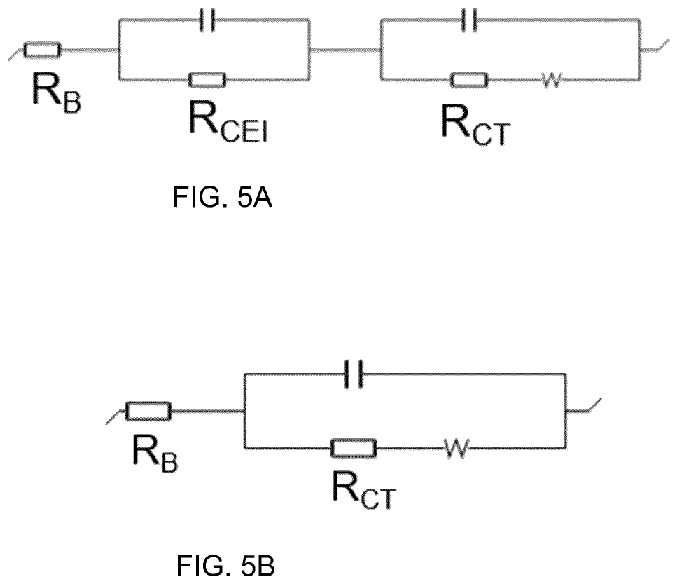

The galvanostatic intermittent titration technique (GITT) was applied to the two positive electrodes at room temperature and −60 ° C. The results of these tests are shown in FIGS. 4A and 4B. The data obtained from the tests were used to calculate the diffusion coefficients for Li⁺ and PF₆⁻ in the LCO and graphite positive electrodes, respectively using a spherical particle model. Referring to FIG. 4C, at 23° C. the average diffusion coefficient was determined to be 2.5×10⁻⁸, and 2.1×10⁻¹⁰ cm² s⁻¹ for the graphite and LCO positive electrodes, respectively. The graphite positive electrode values vary from previous studies, which may be related to a previously established self-activation process that occurs during GITT preparation. When the same analysis was applied at −60° C., these values decreased to 4.1×10⁻¹⁰ cm² s⁻¹ and 7.6×10⁻¹⁴ cm² s⁻¹, where the LCO declined by almost double the orders of magnitude compared to the graphite positive electrode. Such a decrease in the LCO GITT is likely due to the combined effects of solid-state diffusion and de-solvation, whereas the graphite positive electrode only experiences the former. This trend was further investigated by electrochemical impedance spectroscopy (EIS) applied to 50% state of charge (SOC) symmetric positive electrode cells to eliminate any contribution of the shared graphite negative electrode to the charge transfer impedance (FIGS. 4D&4E). The summary of equivalent circuit element values can be found in Table 4, which lists the summarized equivalent circuit values of the 50% SOC LCO∥LCO symmetric cells, and Table 5, which lists the summarized equivalent circuit values of the 50% SOC graphite positive electrode∥graphite positive electrode symmetric cells for different equivalent circuits. The EIS equivalent circuits are shown in FIGS. 5A and 5B. As seen in FIG. 4F, with decreasing temperature, the graphite positive electrode exhibits consistently lower charge transfer impedance (R_{CT}) than LCO, which was measured to be 7.26 Ω and 94.1 Ω, respectively at −60 ° C. In agreement with the GITT results, this trend can be attributed to the elimination of desolvation in the anion storing positive electrodes.

TABLE 4

| Equivalent | Temperature | | | |
|---|---|---|---|---|
| Circuit | (° C.) | R_{bulk} (Ω) | R_{CEI} (Ω) | R_{CT} (Ω) |
| FIG. 5A | 23 | 5.9 | 2.3 | 25.8 |
| | −40 | 13.6 | 4.7 | 62.4 |
| | −50 | 20.7 | 6.3 | 76.5 |
| | −60 | 24.1 | 8.3 | 94.1 |
| FIG. 5B | 23 | 5.9 | n/a | 26.8 |
| | −40 | 13.7 | n/a | 66.4 |
| | −50 | 21.1 | n/a | 80.6 |
| | −60 | 24.8 | n/a | 99.7 |

TABLE 5

| Equivalent | Temperature | | | |
|---|---|---|---|---|
| Circuit | (° C.) | R_{bulk} (Ω) | R_{CEI} (Ω) | R_{CT} (Ω) |
| FIG. 5A | 23 | 5.1 | 0.12 | 1.5 |
| | −40 | 14.8 | 0.34 | 4.8 |
| | −50 | 19.2 | 1.0 | 5.8 |
| | −60 | 23.4 | 2.9 | 7.3 |
| FIG. 5B | 23 | 5.1 | n/a | 1.5 |
| | −40 | 14.8 | n/a | 5.1 |
| | −50 | 19.2 | n/a | 6.7 |
| | −60 | 23.4 | n/a | 9.8 |

It should be noted that there are a few limitations to electrochemical characterization techniques. Specifically, the EIS equivalent circuit and GITT diffusion coefficient model may be insufficient to quantitatively differentiate the effects of solid-state and desolvation effects during charge-transfer. Furthermore, the assumptions inherent in GITT such as negligible volume change, and dominant solid-state diffusion are problematic. While these factors may undermine the quantitative precision of these techniques, the qualitative comparison between the graphite and LCO positive electrodes clearly supports the performance data presented in this work, demonstrating the superiority of the DIB mechanism for low temperature applications.

To summarize, the foregoing demonstrates the kinetic superiority of the salt-splitting charge-transfer mechanism found in DIBs for low temperature operation. Using MP as the primary solvent with a low percentage of FEC provides a novel electrolyte with exceptional ionic conductivity at low temperature and high oxidative stability without compromising graphite negative electrode performance. This electrolyte used in practical dual-graphite and graphite∥LCO full-cells exhibited consistently greater capacity retention compared to the LIBs at the extremely low temperature of −60 ° C., even when their respective performances were comparable at room temperature. The preceding description illustrates the basic principles of the inventive approach of employing an MP-based ester electrolyte to confer high electrochemical stability and ionic conductivity at low temperature for use in low-temperature batteries. The following examples further illustrate the benefits of the MP/FEC electrolyte with variations of the materials.

### EXAMPLE 1

### Fluorinated Ester Electrolyte for High-Voltage LMBs

This example focuses on stabilization of LiNi_{0.8}Co_{0.1}Mn_{0.1}O₂, or NMC 811, cathodes, which has been of interest due to its high operating window (≤4.5V) and high capacity (>200mAh g⁻¹), but which exhibits poor long-term cycling stability compared to cathodes with less Ni, e.g., NMC 523. This is generally believed to be a result of an increased level of parasitic electrolyte reactions at high voltages, an increase level of gas generation, and interfacial phase transformation. Some of these issues have been mitigated using advanced electrolytes. Traditional electrolyte chemistries have not been shown to support high-voltage cathodes for LMBs at extremely low temperatures. The poor energy retention of LIBs at low temperatures has generally been attributed to the internal resistances associated with Li⁺ conduction through the bulk electrolyte, interfacial migration of the Li⁺ at the electrode interfaces, and Li⁺ desolvation. These resistances have been primarily addressed through improvements in the battery electrolyte employing novel salt additive, and employing low-melting point and/or low-polarizability solvents with low viscosity. In spite of this progress, a system providing high energy retention at low temperatures and stable performance for high-voltage cathodes and Li metal anodes has been elusive.

Expanding on the general principles described above relating to use of MP as the primary solvent with a 10% (v/v) FEC additive and a 1 M LiPF₆ salt to form an electrolyte system (referred to as “M9F1”) capable of maintaining electrochemical stability with improved low-temperature performance, an all-fluorinated carboxylate ester-based electrolyte was employed by substituting MP with its fluorinated counterpart, methyl 3,3,3-trifluoropionate (MTFP), which has previously been applied to high-voltage systems as a low-percentage additive. The substitution of fluorine groups is known to decrease the HOMO energy of molecules due to the high ionic potential, high electronegativity, and low polarizability of the fluorine atom, resulting in an increased resistance to oxidation. Applying a 1 M LiPF₆ in a MTFP/FEC (9:1) electrolyte, i.e., M9F1, simultaneously provided high-voltage cathode and Li metal anode reversibility at room temperature, which can be attributed to the production of fluorine-rich interphases formed in the MTFP-based system. Furthermore, the all fluorinated electrolyte provided 161, 149, and 133 mAh g⁻¹ when discharged at −40° C., −50° C., and −60° C., respectively, far exceeding the performance of the commercial electrolyte, and demonstrating the capability of high-voltage operation at ultra-low temperatures.

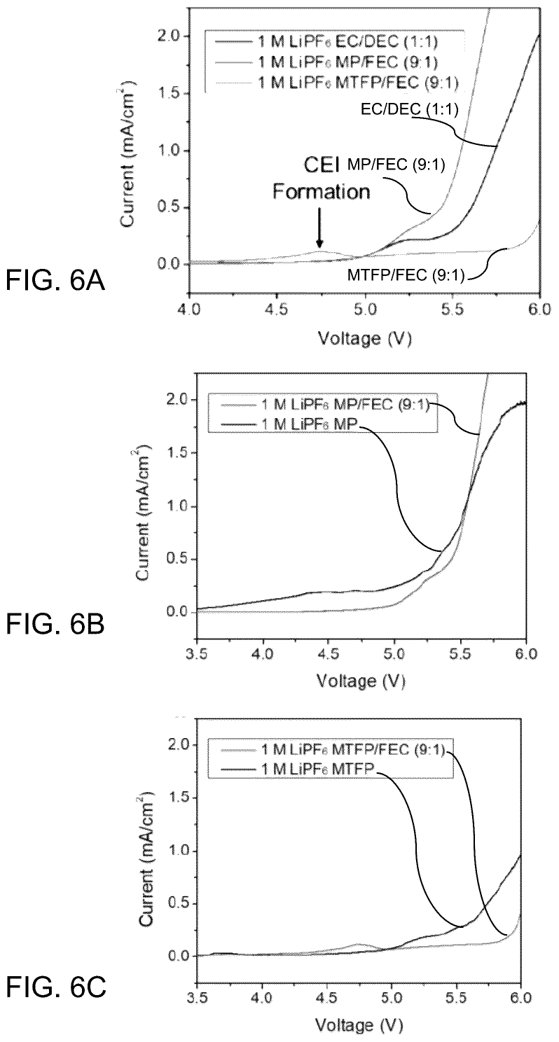

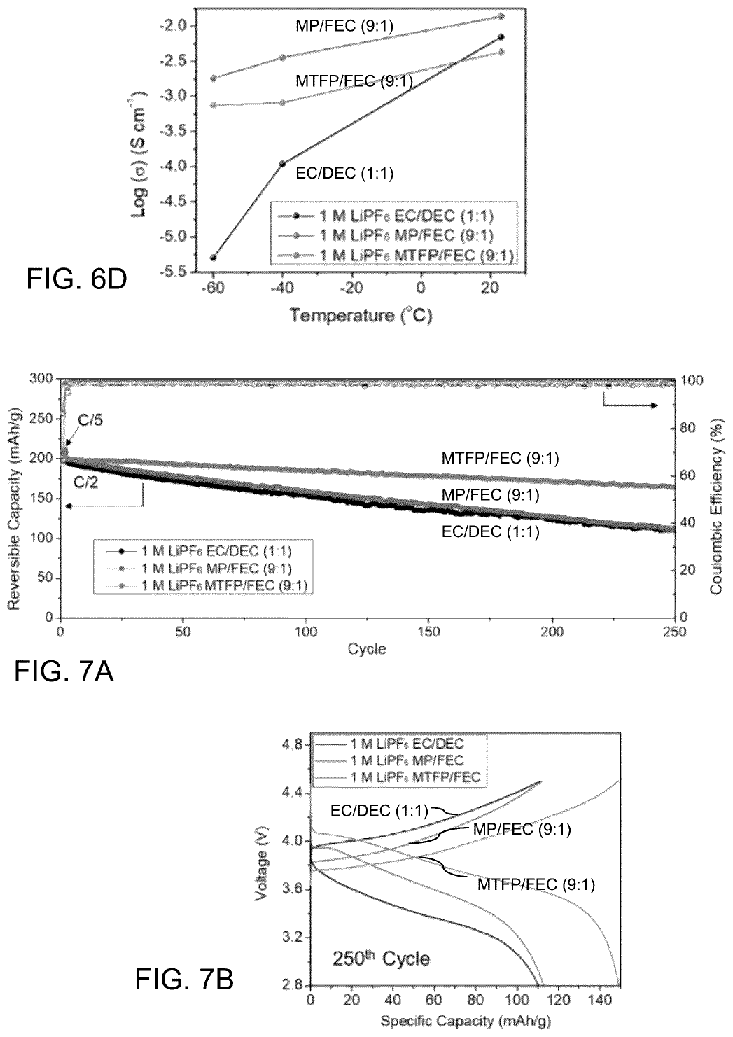

As shown in FIG. 6A, both 1 M LiPF₆ MP/FEC (M9F1) and 1 M LiPF₆ EC/DEC (1:1 volume) systems exhibit significant anodic current at ˜5.0 V versus Li/Li⁺, whereas the 1 M LiPF₆ MTFP/FEC system does not show the same behavior until ˜5.8 V. In both electrolyte systems, the oxidative stability is further increased by the additional of 10% FEC, which is known to form passivating layers on both the anode side and the cathode side, and yields a stability greater than those of the pure solvent systems, as shown in the comparisons in FIGS. 6B and 6C for ester electrolytes with and without FEC at 1 mVs⁻¹ for MP and MTFP, respectively.

As previously stated, designing an electrolyte for ultra-low-temperature batteries requires the use of solvents with a low melting point and low viscosity, yielding a high ionic conductivity at low temperatures. FIG. 6D provides a comparison of the ionic conductivity of selected electrolytes with decreasing temperature measured via electrochemical impedance spectroscopy (EIS). It was found that 1 M LiPF₆ MTFP/FEC displayed a trend comparable to that of 1 M LiPF₆ MP/FEC, where the former retained an ionic conductivity of 0.75 mS cm⁻¹ at −60° C., far exceeding that of 1 M LiPF₆ EC/DEC. which was found to decrease to 0.005 mS cm⁻¹.

For battery electrode preparation, LiNi_{0.8}Co_{0.1}Mn_{0.1}O₂ (NMC 811) powder was purchased from Targray Technology International, Inc. The cathode slurries were prepared by mixing NMC 811, super-P, and polyvinylidene fluoride (PVDF, KYNAR 2800) (8:1:1 mass ratio) in N-methyl pyrrolidone (NMP, Sigma Aldrich >99.5%), which was then cast on aluminum foil and dried overnight under vacuum at 80° C. Blocking electrodes for electrolyte stability determination were prepared by mixing super-P and PVDF (9:1 mass ratio) in NMP, which was then cast on stainless steel and dried under vacuum at 80° C. overnight.

For electrolyte preparation, fluoroethylene carbonate (FEC, >98%) was purchased from Alfa Aesar. Methyl 3,3,3-trifluoroproprionate (MTFP, >98%) was purchased from TCI. LiPF₆ was obtained from BASF. Methyl propionate (MP, >99%) and 1 M LiPF₆ in ethylene carbonate/diethyl carbonate (EC/DEC 1:1, battery grade) were purchased from Sigma Aldrich. MP and MTFP solvents were dried over molecular sieves for at least 24 hours before use in electrolytes. Low-temperature electrolytes were made by dissolving stoichiometric amounts of LiPF₆ in selected solvents under stirring.

A customized two-electrode coin cell was formed using two stainless steel electrodes spaced symmetrically between a PTFE (TEFLON™) washer with a thickness of 0.030 inc. A glass-fiber separator soaked with electrolyte was housed on the inside of the washer to constrain its surface area to a known dimension. To evaluate electrochemical performance, the prepared electrodes were fabricated into two-electrode CR-2032-type coin cells. Half-cells were evaluated with the electrolyte of interest using a Celgard 2400 poly-propylene membrane as the separator and Li metal (99.9%) as the counter electrode, where the working electrode had a typical mass loading of 0.84 mAh cm⁻². Full-cells were evaluated in a similar fashion, where the limited Li metal anode was prepared via electrodeposition in in Li∥Cu coin cells prior to application in full cells, where the plated Li anode was paired with a NMC811 cathode of 1.3 mAh cm⁻² loading. The theoretical capacity of NMC 811 was set to 200 mAh g⁻¹ for the C-rate determination.

To test the practical stability of MP- and MTFP-based electrolytes, cycling tests of NMC811∥Li half-cells were conducted with an aggressive cut-off voltage of 4.5 V to exploit the high capacity of the nickel-rich cathode. As shown in FIG. 7A, the cells in 1 M LiPF₆ MP/FEC and 1 M LiPF₆ EC/DEC retain about 53% of their original capacity after 250 cycles, whiles the 1 M LiPF₆ MTFP-based electrolyte exhibits improved capacity retention of about 80% under the same conditions. FIG. 7B displays the charge-discharge profiles of the 250^{th} cycle of each cell employing the different electrolytes, where greater polarization and capacity degradation can be observed in the cells using the MP-based and carbonate-based electrolytes, likely a consequence of the oxidative decomposition of the electrolyte on the cathode surface.

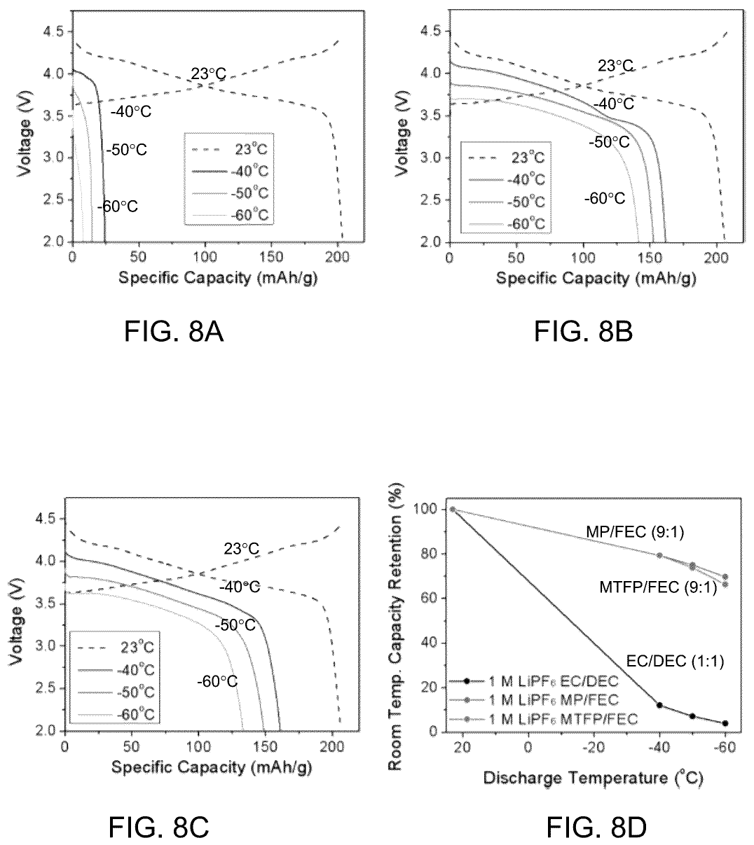

To demonstrate the advantage of the designed ester electrolytes in low temperatures, NMC 811∥Li half-cells were tested using a method in which the cells were charged at room temperature followed by discharge at low temperatures to simulate practice device applications. Without intending to be bound by theory, the primary factors in low-temperature performance degradation are believed to be the reduced bulk ionic conductivity of the electrolyte and a severe reduction in charge transfer kinetics, which has been suggested to be dominated by Li⁺ desolvation. In terms of these metrics, the inventive ester electrolytes appear to be superior in every respect based on the high retention of ionic conductivity at ultralow temperatures and the introduction of FEC, which has been noted to have a Li⁺ solvation energy significantly lower than that of EC, allowing for facile desolvation. The voltage profiles for tests in NMC 811∥Li half-cells are displayed in FIGS. 8A-8C, where FIG. 8A provides the results for 1 M LiPF₆ EC/DEC, FIG. 8B shows 1 M LiPF₆ MP/FEC, and FIG. 8C shows 1 M LiPF₆ MTFP/FEC. The retention versus temperature for each system is summarized in FIG. 8D. From these data, we observe that the typical carbonate electrolyte was unable to support the low temperature operation of the cell, failing to offer any significant capacity (˜10%) at −40° C. due to the high melting point of EC/DEC, as well as the strong binding between Li⁺ and EC. By contrast, the ester electrolytes made remarkable progress in enhancing low-temperature device performance, where the MP/FEC system provided room temperature capacity retention at 79.4%, 75.0%, and 69.7% at −40° C., −50° C., and −60° C., respectively. While the MTFP/FEC system provided slight reduced retention of 73.7% and 66.2% at −50° C. and −60° C., respectively, the relatively small discrepancy is likely due to the reduced ionic conductivity of the MTFP/FEC system.

### EXAMPLE 2

### Ester-Based Electrolyte for NMC∥Graphite Pouch Cells

This example evaluates the effect of the inventive ester electrolyte chemistry on low-temperature charge and discharge behavior in NMC∥graphite type full cells.

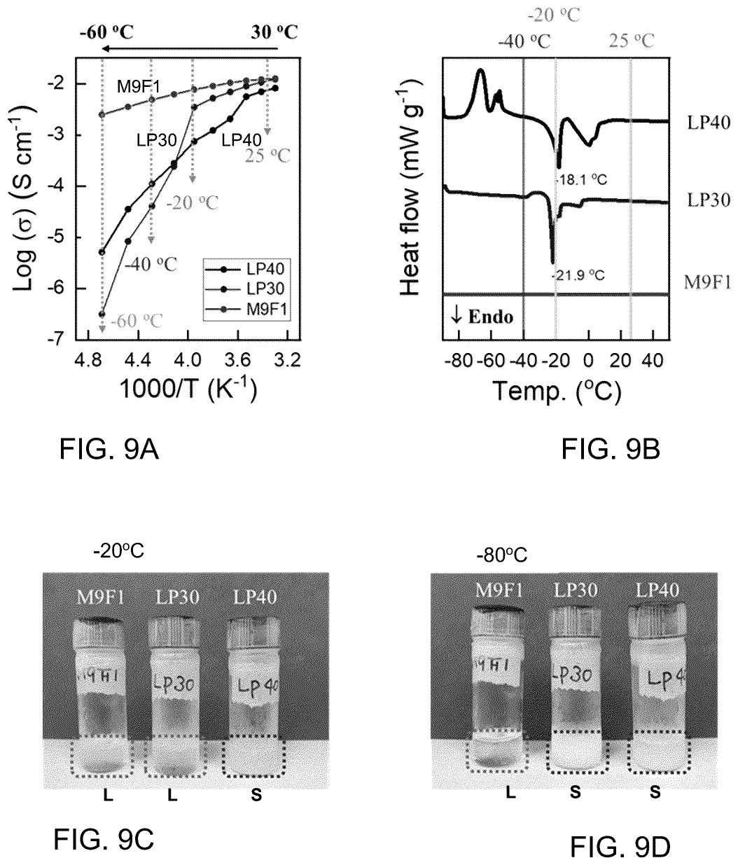

As described above, the ionic conductivities (σᵢ) of the ester-based electrolyte consisting of MP:FEC (90:10 vol. %) with 1 M LiPF₆ (“M9F1”) are significantly improved compared with that of the conventional ethylene carbonate (EC) electrolytes, here identified as LP40 and LP30 (LP40=1 M LiPF₆ in EC: DEC (5:5 vol. %); LP30=1 M LiPF₆ in EC: DMC (5:5 vol. %)), especially at temperatures below −20° C. In FIG. 9A, measurements of a were recorded for each 10° C. Specifically, the σᵢ of M9F1 was found to be 2.48 mS cm⁻¹ at −60° C., whereas LP30 and LP40 showed sudden σᵢ drop from −30° C. and 0° C., respectively, which is typically related to the phase transition from liquid to solid of the electrolytes. For electrolyte phase confirmation, differential scanning calorimetry (DSC) was used to determine that M9F1 did not undergo a phase change between −90° C. and 50° C., despite the relatively high freezing point of FEC. Samples were cooled down to −90° C. and then heated up to 50° C. with 2° C. min⁻¹. The freezing points of the electrolytes were measured under nitrogen atmosphere by DSC (TA instruments, Q2000). Aluminum hermetic pans were used for sampling. FIG. 9B shows DSC heating curves of different electrolytes with 1 M LiPF₆.

LP30 displayed a freezing point at −21.9° C., whereas LP40 was found to exhibit two noticeable endothermic peaks at ˜0.5° C. as well as −18.1° C. These phase transitions have been previously observed in the EC/DEC systems, where the initial peak corresponds to the initial solidification of EC, while we believe the secondary peak at −18.1° C. could be attributed to further internal ordering of the solid similar to a crystallization. The single peak observed in the EC/DMC system is likely due to the significantly closer freezing points of the two solvents as compared to the large difference between EC and DEC (see Table 1 above). The significantly steeper ionic conductivity degradation observed in LP30 is likely indicative of this trend, as liquid DEC is likely still present in the LP40 system below 0° C. These DSC results are also supported through observation of the electrolytes after storing at −20 ° C. and −80° C. for 12 hours. 1 mL of electrolyte solution was added to each glass vial. As shown in FIGS. 9C and 9D, LP40 and LP30 were found to freeze after storage at −20° C., and −40° C., respectively, while M9F1 did not freeze even after days of storage at −80° C. Liquid phase and solid phase are indicated by “L” and “S”, respectively. On the basis of the outstanding ionic transport properties of M9F1,

NMC111∥graphite pouch-type full cells were assembled for electrochemical performance assessment. Briefly, as is known in the art, pouch cells are layered structures in which the electrodes and separators are retained within flexible foil enclosures. These pouch-type full-cells were used to investigate the effects of our designed electrolyte and conventional electrolytes on battery cell performances. Cathode composition=LiNi_{1/3}Mn_{1/3}Co_{1/3}O₂/PVdF (Kynar® HSV 1800)/carbon black (Super-P) at 80:10:10 (wt. %); cathode areal capacity=1.5 mAh cm⁻², anode composition=graphite (GCP-80)/PVdF (Kynar® HSV 1800)/carbon black (Super-P) at 90:5:5 (wt. %); anode areal capacity=1.7 mAh cm⁻². Slurries of positive and negative electrodes were coated on aluminum and copper foils, respectively and dried overnight under vacuum at 80° C. The sizes of the cathode and anode were 44 mm×57 mm and 45 mm×58 mm, respectively. A microporous polyethylene separator (PE) (Celgard 2400) was placed between a cathode and an anode.

The designed electrolyte of this work is 1M LiPF₆ in a mixture of methyl propionate (MP, 99%; Sigma Aldrich) and fluoroethylene carbonate (FEC, >98.0%; TCI Chemical) at 90:10 (vol. %), i.e., M9F1. Both LP40 and LP30 were used as control electrolytes. LP40=1M LiPF₆ in EC/DEC at 50:50 (vol. %) (Sigma Aldrich); LP30=1M LiPF₆ in EC/DMC at 50:50 (vol. %) (Sigma Aldrich).

For the rate capability test at room temperature, the pouch cells were galvanostatically charged to 4.3 V and then held potentiostatically until the current reached 5% of the charge current. Subsequently, the cells were galvanostatically discharged to 2.7 V at different C-rates. For low-temperature cycles, the pouch cells were galvanostatically charged to 4.3V and then potentiostatically charged at the same voltage under room temperature, and then galvanostatically discharged to 2.7 V after switching the temperature to either −20° C. or −40° C. After discharge, the cells were repeatedly charged and discharged at same temperature condition at either −20° C. or −40° C. Battery testers (Neware BTS-4000 and Arbin LBT-10V5A) were used for electrochemical cycling.

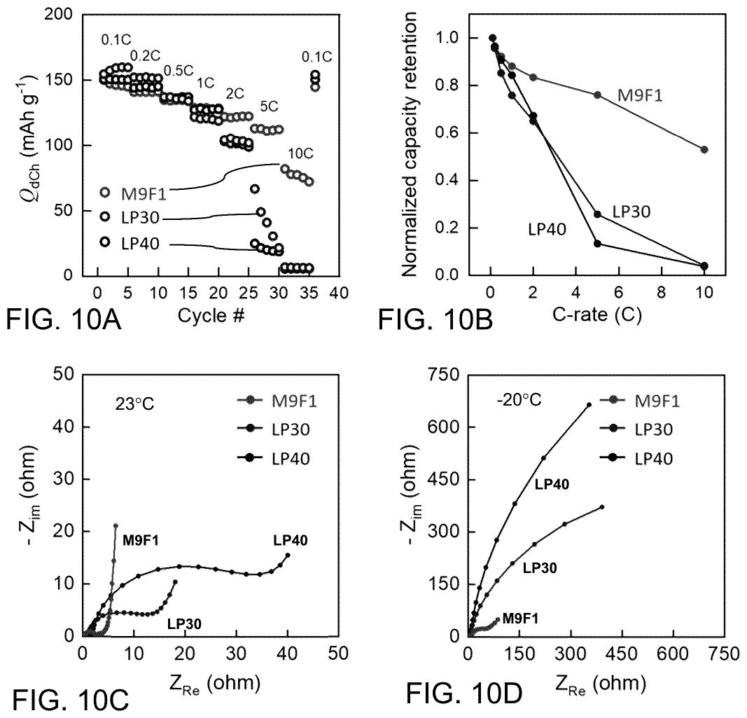

The discharge capacity of the cell was found to be 157.9 mAh g⁻¹ (based on the cathode mass) for M9F1 with clear SEI formation peaks in the initial formation cycle, which was similar to the cells using LP30 and LP40. Next, the discharge rate capability test of the cells was assessed after charging all the cells at 0.1C to observe any variance in kinetic behavior between the electrolytes at room temperature. It was found that M9F1 delivered a discharge capacity of 80 mAh g⁻¹ at the discharge rate of 10C, as shown in FIGS. 10A and 10B. Conversely, almost no discharge capacity was obtained of the cells with LP30 and LP40 under the same conditions. The rate capability of the M9F1 was also found to be significantly improved at 2C and 5C compared with LP30 and LP40.

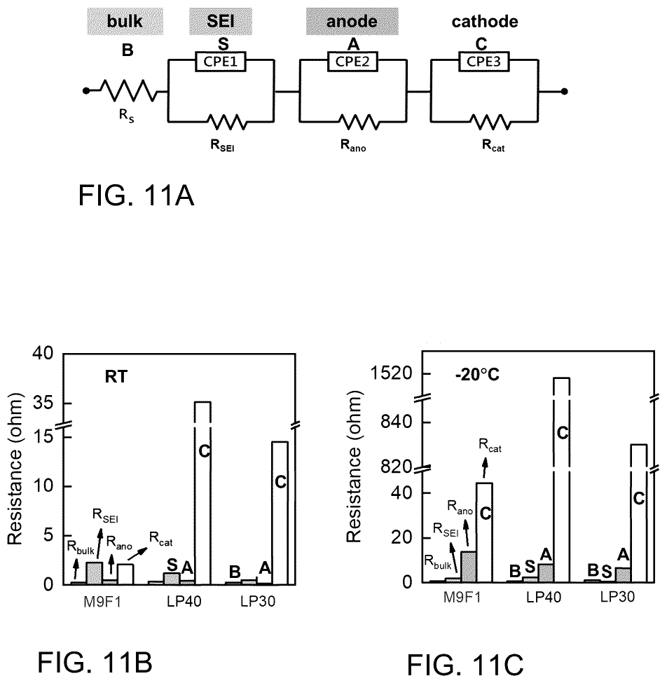

This phenomenon was further investigated by electrochemical impedance spectroscopy (EIS) measurement of the three discharged cells between R.T. and −20° C., respectively, at 0% stage of charge (SOC). The impedance spectra were obtained between 1 mHz to 1 MHz with an AC amplitude of 10 mV at both room temperature and −20° C. For the EIS of three-electrode pouch cells, the cells were pre-cycled for 5 times and then brought to 50% state of charge (SOC). A small, thin lithium metal strip was used as a reference electrode and placed next to the cathode and the anode. The impedance spectra were obtained from 5 mHz to 200 MHz, and from 1 mHz to 1 MHz for room temperature and −20° C. operation, respectively. All impedance spectra were collected by EC-Lab, and component values were obtained by fitting the spectra with a Z-Fit module in EC-Lab. Three-electrode pouch cells subject to low temperature discharge were assembled in small pouch cells, composed of 12-mm diameter anode and cathode electrodes separated by 2 Celgard separators in between which a Li metal reference electrode was placed. These cells were charged at C/5 at their temperatures of interest until the graphite was fully lithiated (0V) before discharge measurements. Average polarization was calculated by subtracting the room temperature voltage of each electrode from their −20° C. voltage at equivalent capacities. The EIS results are shown in FIGS. 10C and 10D for room temperature (RT) and −20° C., respectively. The acquired full-cell impedance spectra can be distinguished by the bulk electrolyte resistance (Rₛ), indicated by “B”, SEI layer resistance (R_{SEI}) (“S”), anode resistance (Rₐₙₒ) (“A”), and cathode resistance (R_{cat}) (“C”), in the equivalent circuit shown in FIG. 11A. In the figure, C_{PE1} is the constant phase element representing capacitance on the interface between electrolyte and SEI layer; CPE2 is constant phase element representing capacitance on the interface between SEI layer and graphite; and CPE3 is the constant phase element representing capacitance on the interface between SEI layer and NMC111. During this analysis, it was found that the R_{cat} of the LP30 and LP40 was substantially higher than Rₐₙₒ compared to the other resistances at both RT and −20° C., as shown in FIGS. 11B and 11C, where the bars are labeled according to the letter codes indicated in FIG. 11A. Furthermore, as seen in FIG. 10D, the cathode resistances of LP30 and LP40 were remarkably increased at −20° C. compared relative to R.T. (FIG. 10C), indicating that the charge transfer resistance (R_{ct}) on the cathode is more limiting in this temperature range. This result suggests that the outstanding cycling at −20° C. may be caused by the extremely low charge transfer resistance on the cathode provided by M9F1.

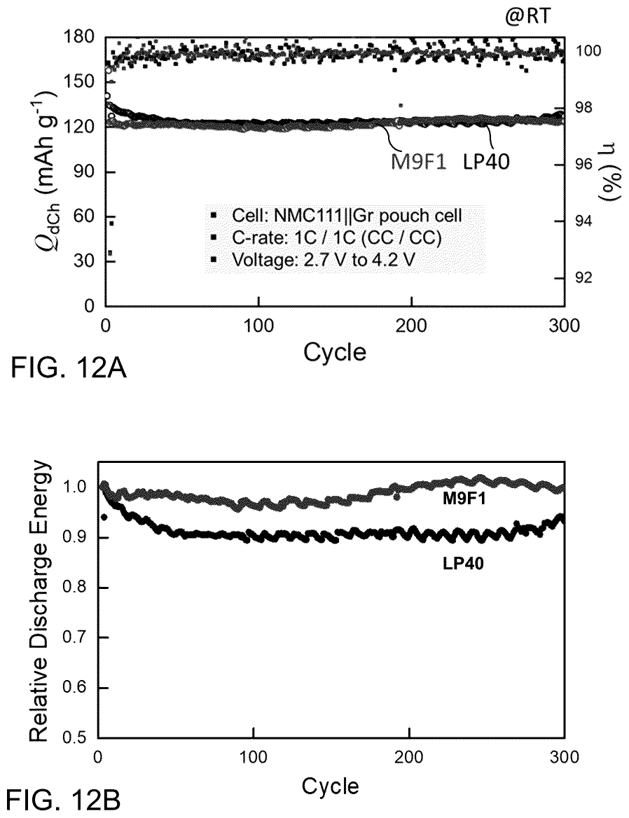

With the assessment of any prospective electrolyte for use in LIBs, it is also vital to address concerns regarding operational reversibility under standard conditions. As such, long cycling tests were conducted in NMC111|graphite pouch-type full cells at room temperature. The cycling test was conducted on 0.1C for 5 cycles, 0.2C for 10 cycles, 0.5C for 10 cycles, and 0.2C for 100 cycles. The first closed circle at each C-rate is the first discharge capacity after charge at room temperature. Following open circles are the repeated charge and discharge cycling after discharge at the same rate at −20° C. As shown in FIG. 12A, a capacity loss of only 0.6% was observed in the M9F1 cell over 300 cycles at 1C charge and discharge cycling, compared to 5.3% observed in the LP40 cell. The M9F1 system was also found to provide similar advantages in the output voltage retention of the system, where the energy loss was found to be only 1.3% for the M9F1 system compared to 7.2% in LP40, shown in FIG. 12B.

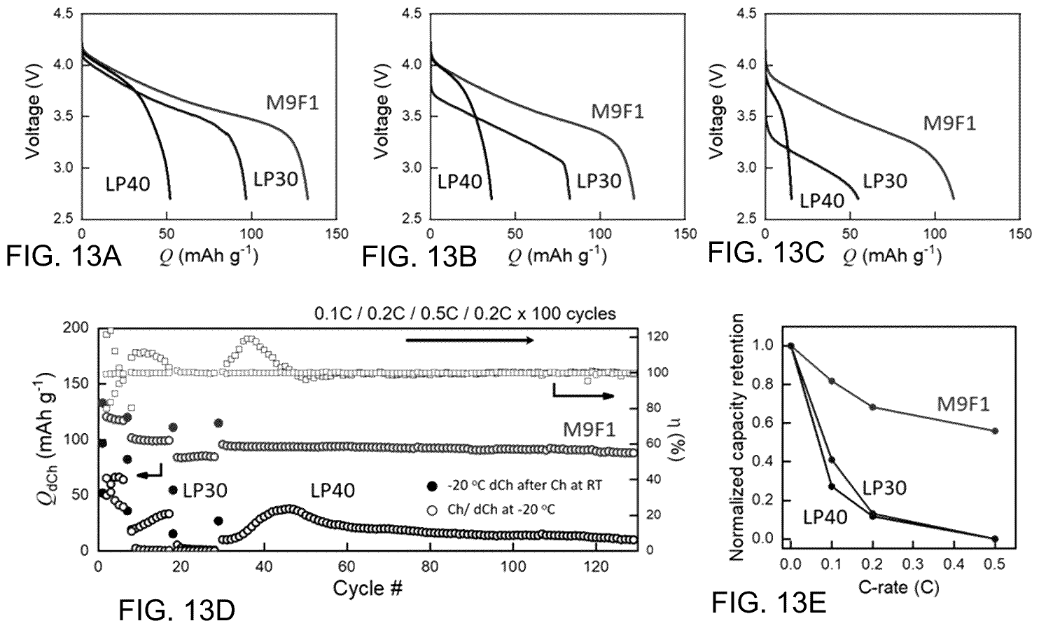

NMC111∥graphite pouch-type full cells were then discharged at −20° C. after they were fully charged at R.T. and a 0.1C rate. Referring to FIGS. 13A-13C, despite similar IR drop behavior, the discharge capacity of M9F1 was found to retain 84% (133mAh g⁻¹) of its R.T. capacity (FIG. 13A), whereas the cells employing LP30 and LP40 displayed 61% and 33% of their R.T. capacity, respectively, under the same conditions. At the higher C-rate of 0.5C, the cell employing M9F1 delivered a discharge capacity retention of 70% (111 mAh g⁻¹) (FIG. 13C). Although the M9F1 system's advantage was clearly shown during discharge, this electrolyte was also found to enable the cycling of these cells at −20° C. (FIG. 13D). As shown in FIG. 13D, after an initial formation charge at R.T. (closed circle), both charge and discharge were conducted at each C-rate under −20° C. Even at 0.1C, the cyclabilities of LP30 and LP40 faded dramatically in the first 5 cycles with significantly unstable coulombic efficiencies (η). The capacity deterioration was more severe at after charge and discharge rates were increased to 0.2C and 0.5C.

Additionally, the LP30 and LP40 electrolytes did not exhibit any significant capacity at the aforementioned higher rates. To the contrary, highly stable capacity retention was recorded at the same operating conditions in the cells employing M9F1. Assessing the last 100 cycles at 0.2C, 92% of the cell capacity was retained (i.e., 88 mAh g⁻¹ of 100^{th}, 95 mAh g⁻¹ of 1^{st} cycle). The retained capacities at −20° C. and each C rate is summarized in FIG. 13E to provide a clearer comparison. The results from these low temperature cycling experiments implies that the charging process of LIBs remains a monumental challenge that can be solved through the application of advanced electrolytes.

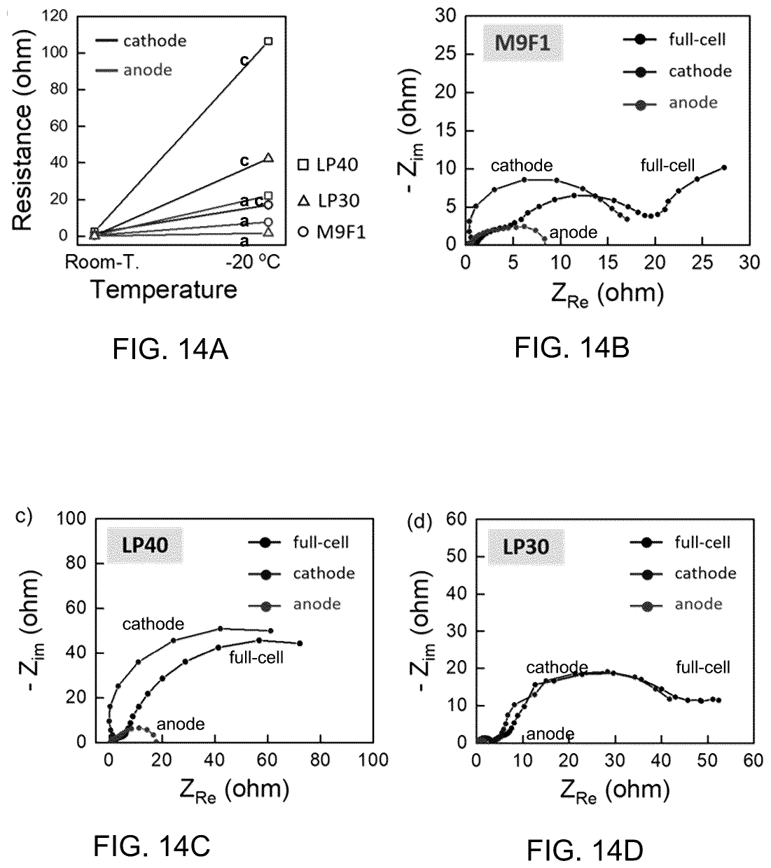

To further confirm the improved low-temperature performance of the cells containing M9F1 during operation, EIS measurements of three-electrode cells was carried out to record the resistances without influence from the counter electrode (CE). In our system, a strip of lithium metal was used as the reference electrode (RE) in the pouch cells, and the EIS was measured at 50% SOC after 5 cycles at 0.1C to ensure the stable formation of SEI and CEI layers. Referring to FIG. 14A, the R_{ct} of cathodes containing LP30 (triangle) and LP40 (square) were remarkably increased at −20° C. relative to R.T., whereas M9F1 (circle) showed significant improvement over the other cells. The relatively increased R_{ct} of LP40-based cells may be caused by the solidification of the electrolyte at −20° C. However, the R_{ct} of the anodes was lower than that of the cathodes, which may suggest that the charge transfer kinetics on the cathodes suffers more on the anodes at −20° C. FIGS. 14B-14D are Nyquist impedance plots of the cells using M9F1, LP40, and LP30, respectively. Impedance of the cells were measured at 50% SOC. Impedance spectra was obtained with a frequency range between 1 mHz to 1 MHz.

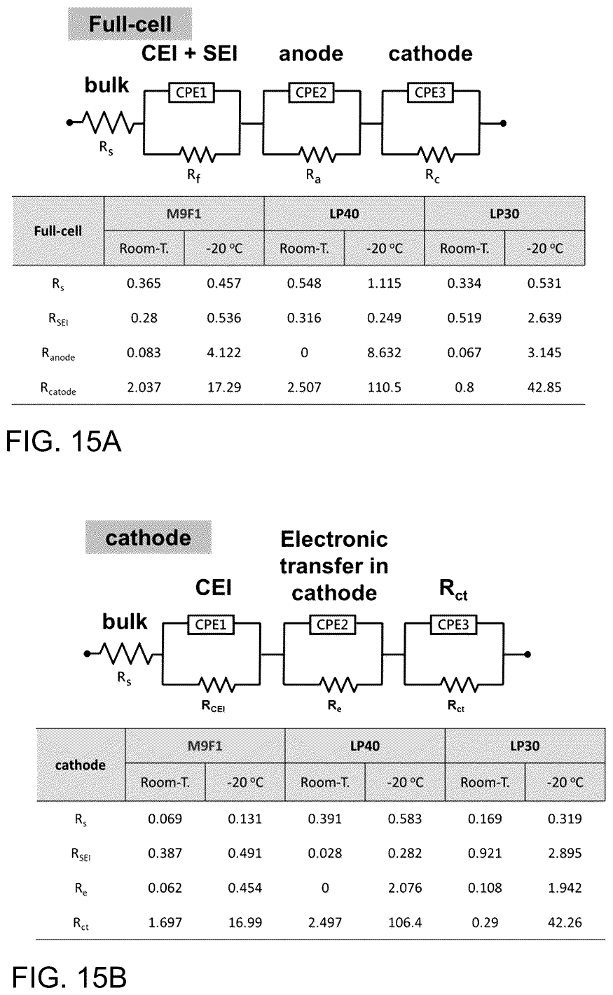

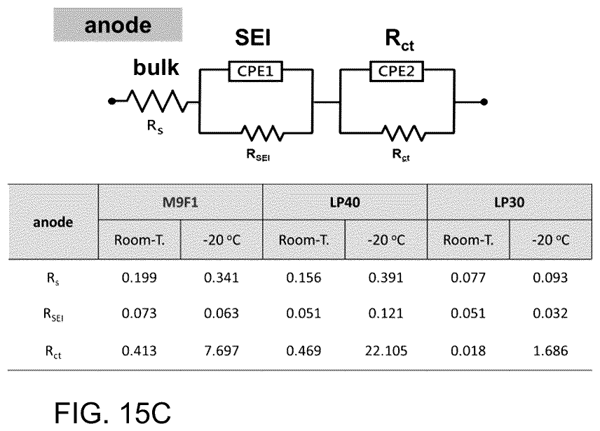

The tables shown in FIGS. 15A-15C list the fitting values for the impedance spectra for three-electrode pouch cells corresponding to the equivalent circuits as shown for full-cell, cathode, and anode, respectively. Compared to LP30 and LP40, M9F1 provided a significantly reduced cathode resistance, which may result from the stable interface film on the electrodes, and the improved physical properties at low-temperature. This trend agrees with the full cell EIS analysis at 0% SOC (FIGS. 10C, 10D). These findings are consistent with a recent study on the positive film-forming behavior of commercial size LiCoO₂∥graphite cells employing electrolytes with an FEC additive, which suggests that the impedance of R_{SEI} and R_{ct} are mainly distributed on the cathode side and that FEC plays a beneficial role.

Three-electrode cells were also investigated for low temperature discharge capability. It was found that the graphite's average polarization between room temperature and −20° C. was 171 and 122 mV for LP30 and M9F1, respectively. The NMC 111, on the other hand showed substantially increased polarizations of 677 and 241 mV for LP30 and M9F1, respectively, which supports the trends revealed by EIS. However, it is important to note that while the polarization of the graphite anode is indeed lower than the NMC 111 cathode, its thermodynamic proximity to Li metal indicates that even small changes in the anode overpotential may result in Li metal plating.

X-ray photoelectron spectroscopy (XPS) was then conducted on the NMC111 cathodes and graphite anodes after cycling at −20° C. to probe the differences in interphase composition. X-ray photoelectron spectroscopy (XPS) was performed with an AXIS Supra DLD XPS by Kratos Analytical, and XPS spectra were corrected using a monochromatized Al Kα radiation (λ=0.83 nm and hv=1,486.7 eV) under a base pressure at 10⁻⁹ Pa. The samples were directly transferred into the XPS chamber from a nitrogen-filled glovebox to avoid moisture and air exposure. Argon plasma of 5 keV was used for etching the electrode surface with a pre-etching for 5 s, etching for 120 s.

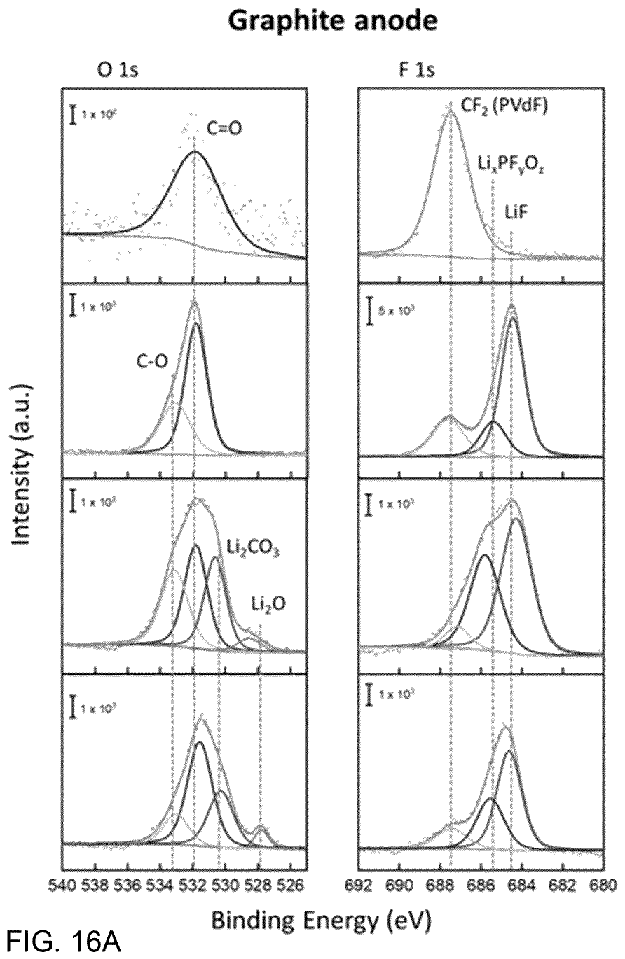

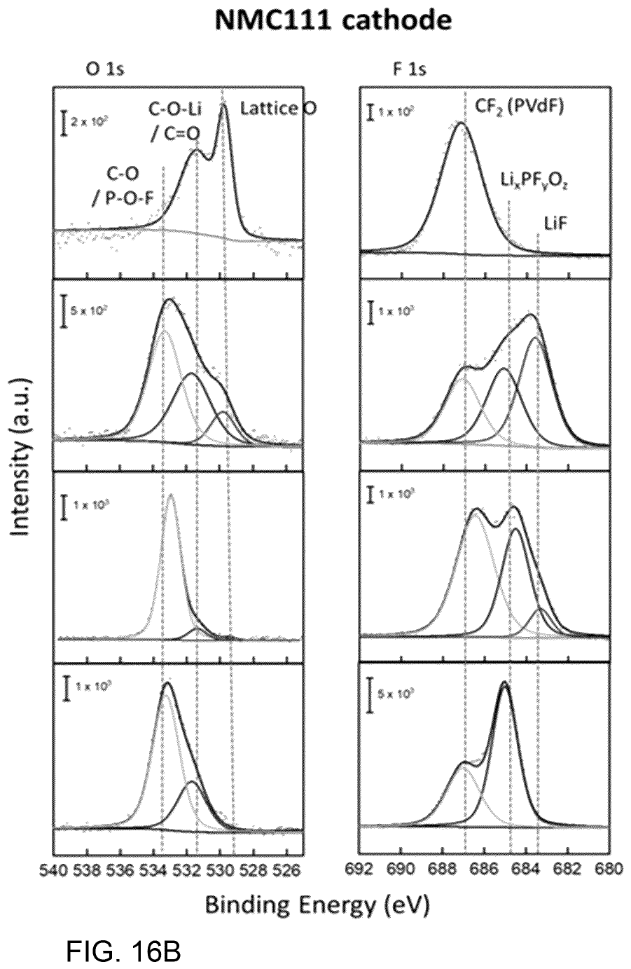

Morphologies on the electrodes were examined by a scanning electron microscopy (SEM) on a Bruker X8-ApexII CCD diffractometer equipped with Mo Kα radiation at kV and 50 mA. Before investigating, all electrode samples were carefully washed by dimethyl carbonate (DMC) to remove the residual electrolyte solvents and salts from the electrodes, which was conducted in an argon-filled glovebox (Mbraun; <0.1 ppm O₂ and H₂O). The XPS results are shown in FIGS. 16A-16B.

As observed in the comparison of O 1s spectra (FIG. 16A, left panel), electrolyte decomposition products of Li₂CO₃ (530.6 eV) and Li₂O (528.5 eV) were detected on the graphite anode cycled in LP40 and LP30 when compared to the pristine spectra. However, the graphite anode cycled in M9F1 reveals clear C═O (˜531.8 eV) and C—O (˜533.1 eV) peaks, which may suggest that the SEI layer formed by FEC and MP was largely free of LiCO₃ species. Further comparison with the F 1s spectra found in FIG. 16A, right panel reveals a strong LiF peak at 684.5 eV in the spectra formed from M9F1, which could be formed from FEC or PF₆⁻ decomposition. However, a relatively high ratio of LiₓPF_{y}O_{z} was detected on the anode of LP40 and LP30, which may indicate the LiF produced in M9F1 is largely formed via FEC. It is worth noting that significant amounts of Li₂CO₃ and Li₂O, have been previously associated with mixtures containing carbonate solvent molecules, and may explain their absence in cathode interface with M9F1 electrolyte, which is composed largely of a carboxylate ester.

From the viewpoint of cathode surface (FIG. 16B, left panel), the significant species found in the O 1s spectra of M9F1 appear as C═O, C—O, and lattice oxygen at ˜533.3 eV, ˜531.7 eV, and ˜529.8 eV, respectively. In the presence of the LP30 and LP40 electrolytes, however, the peak for lattice oxygen disappeared with high intensities of the other peaks. After etching the surface for 120s, however, the clear lattice oxygen peaks were obtained in the presence of LP30 and LP40, which indicates that the CEI formed from these electrolytes were substantially thicker than those formed in M9F1 during cycling at −20° C. As shown in FIG. 16B, right panel, three peaks from the cathodes cycled in M9F1 are present in the F is spectra: i) 683.6 eV ascribed to LiF, which is formed due to the electrochemical decomposition of FEC and LiPF₆; ii) 685.1 eV assigned to LiₓPF_{y}O_{z}, indicative of LiPF₆ decomposition, and iii) 687.1 eV responsible for CF₂ in the PVdF binder. However, the peak intensity of LiF was significantly decreased in the presence of LP40 and LP30 electrolyte with a significant increase of LiₓPF_{y}O_{z}, which indicates that most products of the CEI layer originated from the decomposition of LiPF₆ during cycling. It is believed that the well-known effect on the thin and uniform LiF-rich SEI and CEI layers for electrochemical stability would be beneficial even at low-temperature.

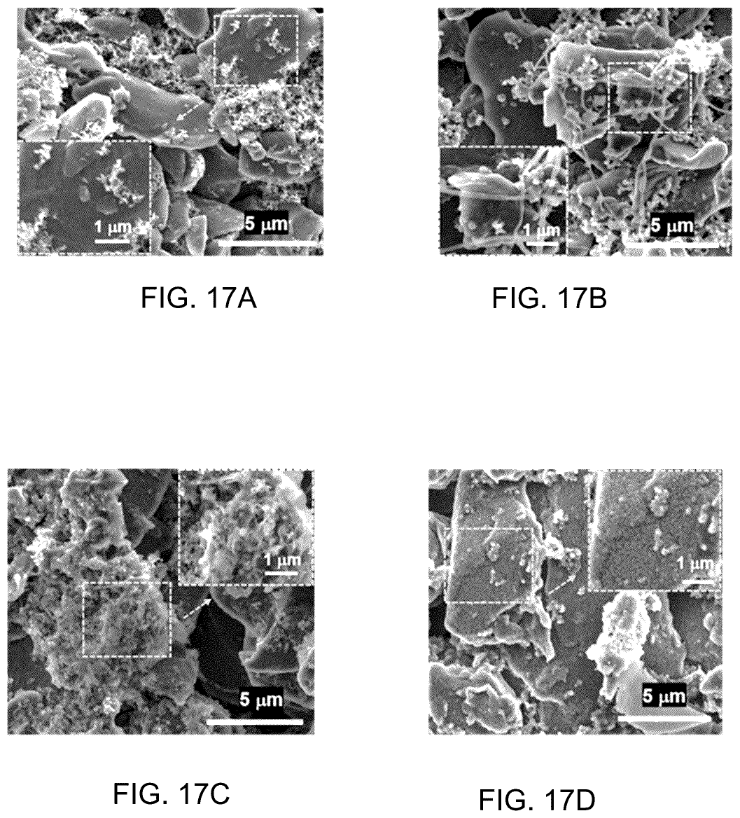

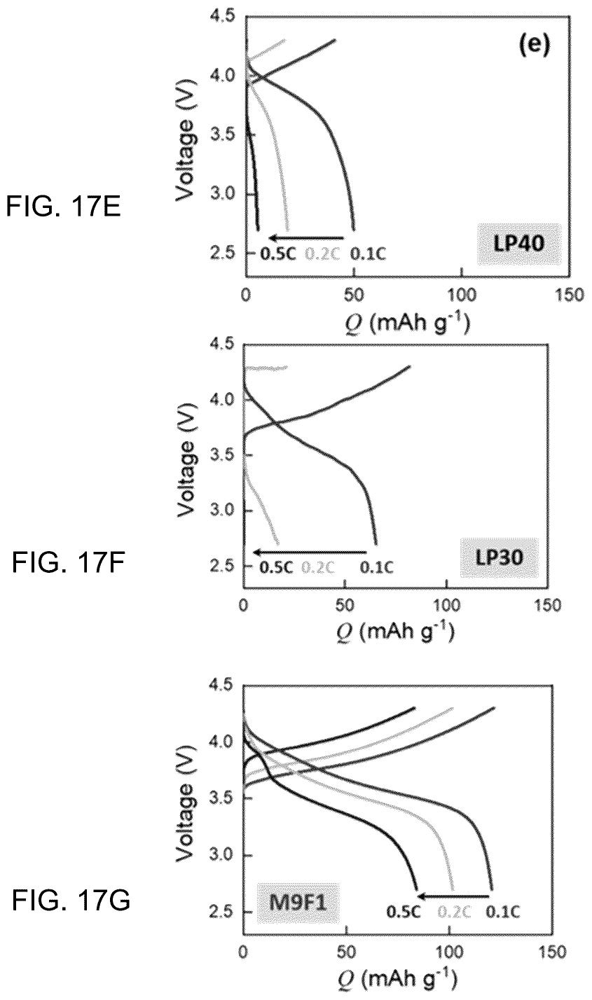

Furthermore, it was found that the resistive nature of the graphite anode encouraged lithium metal plating on the surface during low temperature charging due to its increased polarization. The amount of deposited lithium and the speed of its growth can be controlled by (1) Li⁺ transport limitations, and (2) the interphasial kinetic resistance due to its inhomogeneity, which are exacerbated at sub-zero temperatures. Through the application of scanning electron microscopy (SEM), it was observed that the graphite anodes cycled at −20° C. in LP30 and LP40 presented a significant amount of mossy and dendritic Li (FIGS. 17B and 17C). FIG. 17A shows pristine graphite. By comparison, the anode cycled in M9F1 did not show a significant Li metal presence (FIG. 17D). The growth of Li metal at low temperatures is important to avoid for both the safety and the cycling performance of LIBs. As the highly reactive nature of Li leads to the loss of cyclable Li⁺, and the growth and stripping of such metal leads to a significant increase in SEI, further increasing the polarization of the cell and reducing cell capacity. Referring to FIGS. 17E-17G, this phenomenon is displayed in the coulombic efficiency at −20° C., where the LP30 system displayed an average CE of 94.4% when cycled at C/10, whereas the M9F1 system displayed an average CE of 99.5%. It is worth noting that the presence of Li metal may lead to an increased initial discharge voltage due to the decreased potential of Li in relation to graphite. While this is ostensibly a performance improvement, the extremely diminished cycle life coincident with such plating events as well as the safety concerns associated with dendrites poses an extreme concern for LP30 and LP40 device operation at low temperatures. Though much higher capacity can be achieved by M9F1 electrolyte at low temperature, the small upper voltage plateau shown in the discharge curve at 0.5C from the M9F1 electrolyte (FIG. 17G) suggests the existence of Li deposition on the anode during charging at low temperature. Nonetheless, the relatively clean surface of the graphite particles with small roughness indicates that this insignificant amount of Li deposition is uniform.

Cell gassing testing was performed through three-layer pouch-type full cells (cell capacity ˜120 mAh) and the gas volume was measured using the Arrhenius method according to Dahn et al. Cells were weighed while submerged in deionized water (18MΩ cm) before and after the experiment. The difference in weight of the pouch cell while submerged in water is then directly proportional to the volume of gas produced. The volume of the gas generated after cycling is then calculated by the following equations:

$$Density of the cell = \frac{Weight in air}{Weight in air - Weight in water} \times Density of water \qquad ( 2 )$$

$$Volume of gas generation = \frac{Weight of the cell}{density before cycling} - \frac{Weight of the cell}{density after cycling} \qquad ( 3 )$$

It was found that after 8 cycles at 0.1C, the cell employing M9F1 ester electrolyte generated only 0.042 mL of gas compared to 0.1532 mL generated by the carbonate system. See Table 6 below.

TABLE 6

| Weight (g) | LP30 | M9F1 | M95F5 |
|---|---|---|---|
| In air | 6.7758 | 6.4924 | 6.5615 |
| In water | 2.9801 | 2.8806 | 2.9733 |
| (before cycling) | 2.8272 | 2.8386 | 2.780 |
| In water | | | |
| (after 8^{th} cycle) | | | |
| Gas generation | 0.1532 | 0.042 | 0.1933 |
| volume (ml) | | | |

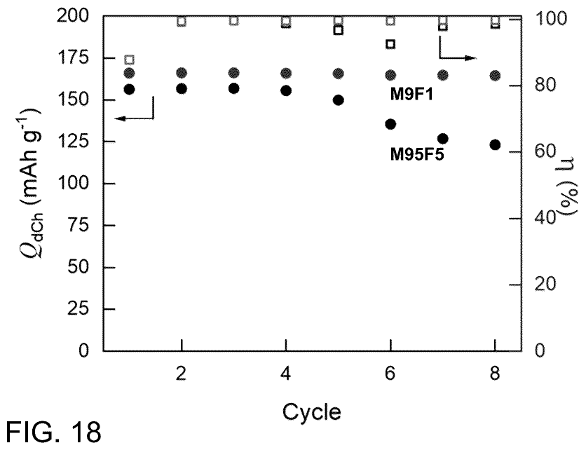

The importance of the low-percentage FEC content was also observed via the gassing and cycling comparison between the M9F1 system, and a M95F5 formulation (MP:FEC=95:5 in vol.), where the capacity was shown to sharply decay after only 5 cycles (FIG. 18), generating 0.1933 mL of gas after 8 cycles. These results not only indicate the practical viability of the M9F1 system for scale-up, but also reveal the contribution of ˜10% FEC content in passivating the electrode surface, allowing for stable cycling and reduced gas generation.

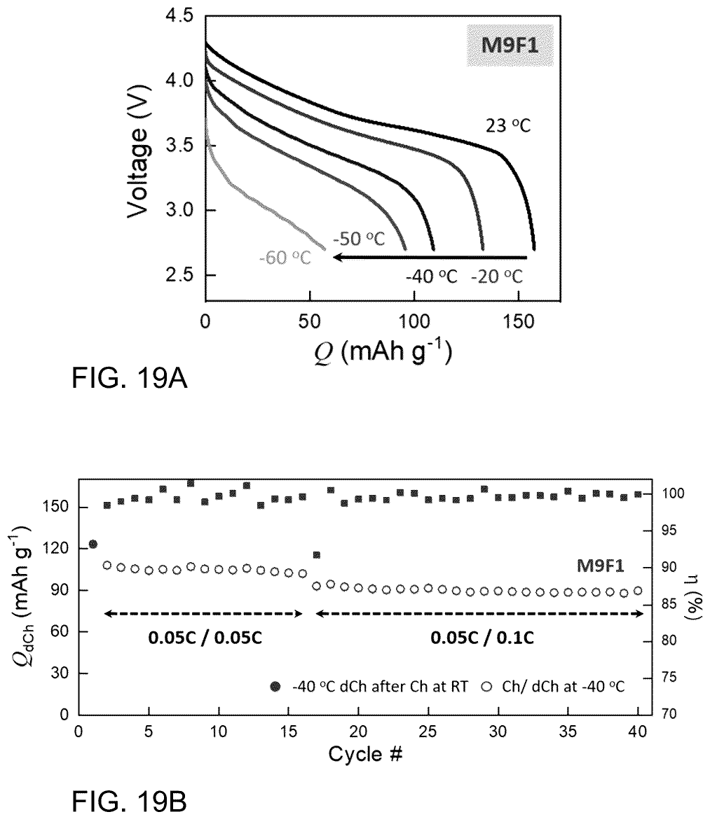

While the advantage of the M9F1 electrolyte is clear at −20° C., its ionic conductivity of 2.48 mS cm⁻¹ of M9F1 at −60° C. indicates that this electrolyte may enable stable performance at even lower temperatures (FIG. 19A). To demonstrate this, ionic conductivity of the electrolytes was measured by a customized stainless-steel two-electrode cells, in which two polished 316 stainless-steel (SS 316) were spaced symmetrically. The cell constant for calibration was performed from 0.447 to 80 mS cm⁻¹ by using OAKTON standard conductivity solution. The ionic conductivities were calculated using the following equation: σᵢ=L/(A×R) , where L and A are the length and area of internal space between the electrodes, respectively, and R is the solution resistance. The data for ionic conductivities was measured by Lab View Software, which was used to control an ESPEC BTX-475 temperature chamber and stored for 30 minutes intervals before measurement.

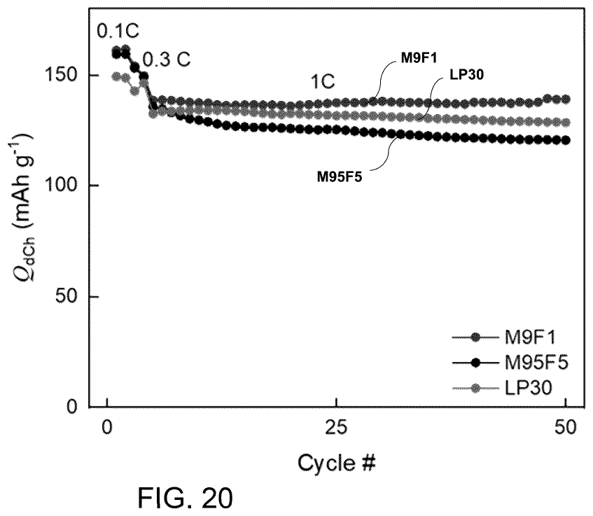

The pouch cells employing M9F1 were also cycled at −40° C., which produced a discharge capacity of 109 mAh g⁻¹ at a 0.1C rate. Furthermore, when cycled, the M9F1 cell was able to display a 94.5% and 96.3% capacity retention under 0.05C/0.05C, and of charge and discharge, respectively, as well as maintaining stable coulombic efficiencies. These results are shown in FIG. 19B where the first closed circle indicates the first discharge capacity after charge at room temperature. Following open circles indicate the repeated charge and discharge cycling after discharge at the same temperature of −40° C. Note that LP30 and LP40 cells were not able to deliver any capacity due to poor transport properties and large electrolyte/electrode interfacial resistances at such a low temperature. In order to determine battery operation across a wide temperature range for broader applications, high temperature performance of the ester electrolyte was evaluated to provide a more wholistic system assessment. NMC 111∥graphite pouch-type full cells were assembled with different electrolytes and cycled at 45° C. The cycling test was conducted first at 0.1C for 2 cycles at room-temperature for activation, then the cells were transferred into the temperature chamber cycling at 0.3C for 2 cycles, 1C for the rest of cycles at 45° C. As shown in FIG. 20, after activation at room temperature, the M9F1 cell was able to maintain stable 1C cycling with no capacity degradation after 50 cycles at the elevated temperature. In contrast, the LP30 cell showed slightly lower initial capacity with an overall degradation of 4% at 1C. While the M95F5 cells exhibited a similar initial capacity with M9F1 cell at low rate, its capacity loss reached 10% after cycles, indicating the important role of having a critical composition of FEC in the ester-based electrolyte. This result suggests that the inventive ester electrolyte disclosed herein can be tailored for wide-temperature applications.

The capacity retention as well as Coulombic efficiency of NMC111∥graphite pouch-type full-cells can be significantly improved in the presence of an MP-based ester electrolyte, M9F1, at the sub-zero temperatures of −20° C. and −40° C. This electrolyte enables ionic conductivity at low-temperatures with an extremely low freezing point and LiF-rich interface layers on the cathode and anode, which facilities charge transfer at both charge and discharge cycling. The 1M LiPF₆ in MP: FEC electrolyte was effective in: (1) enhancing rate capability at room-temperature and outstanding discharge properties at low-temperatures even at −40° C., and (2) protecting the cathode and anode by suppressing thick SEI layer formation and metallic Li deposition. Based on the above-described testing of the ester-based electrolyte in different battery types, the inventive electrolyte formula can be used to improve the low-temperature performance of a variety of electrode chemistries.

1. An electrolyte for a lithium battery comprising:
a lithium salt;
a primary solvent having a low melting point;
a secondary solvent having a high electrochemical stability, wherein the secondary solvent is combined with the primary solvent at a volume % of about 5% to about 30%.

2. The electrolyte of claim 1, wherein the primary solvent is selected from the group consisting of methyl propionate (MP), methyl butyrate (MB), methyl acetate (MA), methyl formate (MF), ethyl propionate (EP), ethyl butyrate (EB), and propyl butyrate (PB).

3. The electrolyte of claim 1, wherein the secondary solvent is an comprises ethylene carbonate or fluoroethylene carbonate (FEC).

4. (canceled)

5. The electrolyte of claim 1, wherein the primary solvent is methyl propionate (MP) and the secondary solvent is fluoroethylene carbonate (FEC), wherein a ratio of MP to FEC is 90:10 vol. %.

6. The electrolyte of claim 1, wherein the lithium battery is selected from the group consisting of graphite∥graphite dual-ion batteries (DIB), Li-sulfurized polyacrylonitrile (Li∥SPAN) batteries, graphite∥LiMnₓNi_{y}Co_{z}O₂ (NMC) batteries, graphite∥LiCoO₂ batteries, graphite∥LiMn₂O₄ batteries, and graphite∥LiFePO₄ batteries.

7-8. (canceled)

9. The electrolyte of claim 1, wherein the lithium battery comprises a graphite anode and a cathode selected from LiCoO₂, NMC, LiMn₂O₄, LiFePO₄, SPAN, transition metal oxides, sulfides, fluorides, and combinations thereof.

10. The electrolyte of claim 1, wherein the lithium salt comprises 1M to 2 M LiPF₆ in a solvent comprising MP with 10% (v/v) FEC.

11. A method for enhancing electrochemical stability of a battery electrolyte in a lithium battery comprising adding ethylene carbonate (EC) in an amount of about 5% to about 30% to a primary solvent having a low melting point.

12. The method of claim 11, wherein the primary solvent is selected from the group consisting of methyl propionate (MP), methyl butyrate (MB), methyl acetate (MA), methyl formate (MF), ethyl propionate (EP), ethyl butyrate (EB), and propyl butyrate (PB).

13. The method of claim 11, wherein the primary solvent is methyl propionate (MP) and a ratio of MP to EC is 90:10 vol. %.

14. The method of claim 11, wherein the lithium battery is selected from the group consisting of graphite∥graphite dual-ion batteries (DIB), Li-sulfurized polyacrylonitrile (Li∥SPAN) batteries, graphite∥LiMnₓNi_{y}Co_{z}O₂ (NMC) batteries, graphite∥LiCoO₂ batteries, graphite∥LiMn₂O₄ batteries, and graphite∥LiFePO₄ batteries.

15-16. (canceled)

17. The method of claim 11, wherein the lithium battery comprises a graphite anode and a cathode selected from LiCoO₂, NMC, LiMn₂O₄, LiFePO₄, SPAN, transition metal oxides, sulfides, fluorides, and combinations thereof.

18. The method of claim 11, wherein the battery electrolyte comprises 1M to 2 M LiPF₆ in a solvent comprising MP with 10% (v/v) FEC.

19. An electrolyte for a lithium battery comprising a lithium salt in a solvent comprising an ester primary solvent and a low percentage of about 5% to about 30% of ethylene carbonate (EC).

20. The electrolyte of claim 19, wherein the ethylene carbonate is fluoroethylene carbonate (FEC).

21. The electrolyte of claim 19, wherein the ester primary solvent is selected from the group consisting of methyl propionate (MP), methyl butyrate (MB), methyl acetate (MA), methyl formate (MF), ethyl propionate (EP), ethyl butyrate (EB), and propyl butyrate (PB).

22. The electrolyte of claim 19, wherein the primary solvent is methyl propionate (MP) and the ethylene carbonate is fluoroethylene carbonate (FEC), and wherein a ratio of MP to FEC is 90:10 vol. %.

23. The electrolyte of claim 19, wherein the lithium battery is selected from the group consisting of graphite∥graphite dual-ion batteries (DIB), Li-sulfurized polyacrylonitrile (Li∥SPAN) batteries, graphite∥LiMnₓNi_{y}Co_{z}O₂ batteries, graphite∥LiCoO₂ batteries, graphite∥LiMn₂O₄ batteries, and graphite∥LiFePO₄ batteries.

24. (canceled)

25. The electrolyte of claim 19, wherein the lithium battery comprises a graphite anode and a cathode selected from LiCoO₂, NMC, LiMn₂O₄, LiFePO₄, SPAN, ether transition metal oxides, sulfides, fluorides, and combinations thereof.

26. The electrolyte of claim 19, wherein the lithium salt comprises LiPF₆.

27. The electrolyte of claim 26, wherein the LiPF₆ is 1M to 2 M in a solvent comprising MP with 10% (v/v) FEC.

28. A lithium battery having enhanced electrochemical stability comprising:
a graphite anode;
a cathode selected from LiCoO₂, NMC, LiMn₂O₄, LiFePO₄, SPAN, a transition metal oxide, a sulfide, a fluoride, and a mixture thereof; and
an electrolyte comprising a lithium salt and a mixture of a primary solvent and an amount of about 5% to about 30% ethylene carbonate.

29. (canceled)

30. The lithium battery of claim 28, wherein the lithium salt is LiPF₆.

31. The lithium battery of claim 28, wherein the ethylene carbonate is fluoroethylene carbonate (FEC).

32. The lithium battery of claim 28, wherein the primary solvent is selected from the group consisting of methyl propionate (MP), methyl butyrate (MB), methyl acetate (MA), methyl formate (MF), ethyl propionate (EP), ethyl butyrate (EB), and propyl butyrate (PB).

33. The lithium battery of claim 31, wherein the primary solvent is methyl propionate (MP) and a ratio of MP to FEC is 90:10 vol. %.

34. The lithium battery of claim 28, wherein the lithium battery is selected from the group consisting of graphite∥graphite dual-ion batteries (DIB), Li-sulfurized polyacrylonitrile∥SPAN) batteries, graphite∥LiMnₓNi_{y}Co_{z}O₂ batteries, graphite∥LiCoO₂ batteries, graphite∥LiMn₂O₄ batteries, and graphite∥LiFePO₄ batteries.

35-36. (canceled)

37. The lithium battery of claim 28, wherein the electrolyte comprises 1M to 2 M LiPF₆ in a solvent comprising MP with 10% (v/v) FEC.
